(19) United States
(12) Patent Application Publication
(10) Pub. No.: US 2025/0321585 A1
(43) Pub. Date: Oct. 16, 2025

(54) UNMANNED AERIAL VEHICLE, AND CONTROL SYSTEM AND CONTROL METHOD FOR UNMANNED AERIAL VEHICLE

(71) Applicant: Kubota Corporation, Osaka (JP)

(72) Inventors: Kohei SEINO, Sakai-shi (JP); Mitsuru ISHIKAWA, Ota-shi (JP); Hiroyuki NAGASHIMA, Ota-shi (JP)

(21) Appl. No.: 19/247,996

(22) Filed: Jun. 24, 2025

Related U.S. Application Data
(63) Continuation of application No. PCT/JP2022/048184, filed on Dec. 27, 2022.

(51) Int. Cl. G05D 1/49; G05D 109/25

(52) U.S. Cl. CPC G05D 1/49; G05D 2109/254

(57) ABSTRACT

An unmanned aerial vehicle includes a plurality of rotors including a plurality of first rotors and at least one second rotor, and a controller configured or programmed to perform attitude control of a body of the vehicle by controlling rotation of the plurality of first rotors, and generate a main thrust by controlling rotation of the at least one second rotor. The controller is configured or programmed to calculate a first thrust that is a total thrust to be generated by the plurality of first rotors, and calculate a second thrust that is a total thrust to be generated by the at least one second rotor, based on the first thrust and the total thrust needed for flight, determine a rotational speed of each of the plurality of first rotors based on the first thrust, and determine a rotational speed of the at least one second rotor based on the second thrust.

### CROSS REFERENCE TO RELATED APPLICATIONS

This application is a continuation application of PCT Application No. PCT/JP2022/048184 filed on Dec. 27, 2022. The entire contents of this application are hereby incorporated herein by reference.

### BACKGROUND OF THE INVENTION

### 1. Field of the Invention

The present disclosure relates to unmanned aerial vehicles, and control systems and control methods for unmanned aerial vehicles.

### 2. Description of the Related Art

An unmanned aerial vehicle (UAV) is an aircraft that structurally cannot accommodate human occupants and is capable of flight through remote control or autonomous operation. A rotary-wing type unmanned aerial vehicle is a UAV that generates lift using propellers, namely rotary wings, which rotate around an axis. A small unmanned aerial vehicle including multiple rotary wings (Multi-Rotor UAV) is also called a “drone”, “multirotor”, or “multicopter”, and is widely used for applications including aerial photography, surveying, logistics, and agricultural spraying.

Japanese Patent Application Publication No. 2022-104737 describes an unmanned aerial vehicle (unmanned flying body) that changes its flight position in coordination with the operation of an agricultural machine.

Japanese Patent Application Publication No. 2019-59362 describes an unmanned aerial vehicle (autonomous flight apparatus) that can increase payload and continuous flight time, and can accurately adjust position and attitude during flight.

### SUMMARY OF THE INVENTION

The maximum payload capacity (payload) and flight duration of unmanned aerial vehicles may be insufficient depending on the application, and further improvements are desired.

Example embodiments of the present disclosure provide unmanned aerial vehicles suitable for agricultural applications, capable of increasing payload and/or flight duration.

The present disclosure provides solutions described in the following items.

[Item A1] An unmanned aerial vehicle including a plurality of first rotors, a plurality of second rotors, a controller configured or programmed to perform attitude control by controlling rotation of the plurality of first rotors and generate a main thrust by controlling rotation of the plurality of second rotors, wherein the controller is configured or programmed to reduce a total thrust of the plurality of second rotors when performing rudder control to adjust a yaw angle of a body of the vehicle by controlling the rotation of the plurality of first rotors.

[Item A2] The unmanned aerial vehicle according to Item A1, wherein the controller is configured or programmed to reduce the total thrust of the plurality of second rotors by decreasing a rotational speed of each of the plurality of second rotors.

[Item A3] The unmanned aerial vehicle according to Item A1 or A2, wherein the controller is configured or programmed to perform the rudder control when controlling the yaw angle to a target angle, when a control delay in the yaw angle occurs, or when rotation or oscillation in the yaw direction occurs.

[Item A4] The unmanned aerial vehicle according to any one of Items A1 to A3, wherein a diameter of each of the plurality of second rotors is larger than a diameter of each of the plurality of first rotors.

[Item A5] The unmanned aerial vehicle according to any one of Items A1 to A4, wherein a thrust per revolution of each of the plurality of second rotors is greater than a thrust per revolution of each of the plurality of first rotors.

[Item A6] The unmanned aerial vehicle according to any one of Items A1 to A5, wherein a distance from a center of the body to a rotation axis of each of the plurality of second rotors is shorter than a distance from the center of the body to a rotation axis of each of the plurality of first rotors.

[Item A7] The unmanned aerial vehicle according to any one of Items A1 to A6, wherein the controller is configured or programmed to make the total thrust of the plurality of second rotors greater than a total thrust of the plurality of first rotors during hovering, and make the total thrust of the plurality of second rotors less than the total thrust of the plurality of first rotors when performing the rudder control.

[Item A8] The unmanned aerial vehicle according to any one of Items A1 to A7, wherein the controller is configured or programmed to decrease a rotational speed of each of the plurality of second rotors to reduce the total thrust of the plurality of second rotors by about 5% or more when performing the rudder control.

[Item A9] The unmanned aerial vehicle according to Item A8, wherein the controller is configured or programmed to compensate for a decreased total thrust of the plurality of second rotors due to a decreased rotational speed of each of the plurality of second rotors by increasing the rotational speed of the plurality of first rotors when performing the rudder control.

[Item A10] The unmanned aerial vehicle according to any one of Items A1 to A9, wherein the controller is configured or programmed to stop the rotation of each of the plurality of second rotors when performing the rudder control.

[Item A11] The unmanned aerial vehicle according to any one of Items A1 to A10, further including a plurality of electric motors each to drive a respective one of the plurality of first rotors, and an internal combustion engine to drive the plurality of second rotors, wherein the controller is configured or programmed to control the rotation of the plurality of first rotors by controlling the plurality of electric motors, and control the rotation of the plurality of second rotors by controlling the internal combustion engine.

[Item A12] A control method for an unmanned aerial vehicle including a plurality of first rotors and a plurality of second rotors, the control method including performing attitude control of a body of the vehicle by controlling rotation of the plurality of first rotors, generating a main thrust by controlling rotation of the plurality of second rotors, wherein performing the attitude control includes executing rudder control to adjust a yaw angle of the body by controlling rotation of the plurality of first rotors, and reducing a total thrust of the plurality of second rotors when executing the rudder control.

[Item B1] An unmanned aerial vehicle including a plurality of rotors including a plurality of first rotors and at least one second rotor, and a controller configured or programmed to perform attitude control of a body of the vehicle by controlling rotation of the plurality of first rotors and generate main thrust by controlling rotation of the at least one second rotor, wherein the controller is configured or programmed to calculate a first thrust that is a total thrust to be generated by the plurality of first rotors and calculate a second thrust that is a total thrust to be generated by the at least one second rotor based on the first thrust and a total thrust needed for flight, determine a rotational speed of each of the plurality of first rotors based on the first thrust, and determine a rotational speed of the at least one second rotor based on the second thrust.

[Item B2] The unmanned aerial vehicle according to Item B1, wherein the controller is configured or programmed to calculate the second thrust by subtracting the first thrust from the total thrust needed for flight.

[Item B3] The unmanned aerial vehicle according to Item B1, wherein the controller is configured or programmed to determine the first thrust by multiplying the total thrust needed for flight by a first coefficient ranging from 0 to 1 inclusive, and determine the second thrust by multiplying the total thrust by a second coefficient that is obtained by subtracting the first coefficient from 1, or by multiplying the first thrust by a third coefficient that is obtained by dividing the second coefficient by the first coefficient.

[Item B4] The unmanned aerial vehicle according to Item B3, wherein the controller is configured or programmed to change the first coefficient, and the second coefficient or the third coefficient, according to a state of the unmanned aerial vehicle.

[Item B5] The unmanned aerial vehicle according to Item B3 or B4, wherein the controller is configured or programmed to set the first coefficient to a value less than about 0.5 during hovering.

[Item B6] The unmanned aerial vehicle according to any one of Items B3 to B5, wherein the controller is configured or programmed to determine the second thrust by multiplying the first thrust by the third coefficient.

[Item B7] The unmanned aerial vehicle according to any one of Items B3 to B6, wherein the controller is configured or programmed to change the first coefficient, and the second coefficient or the third coefficient, according to the flight mode.

[Item B8] The unmanned aerial vehicle according to any one of Items B3 to B7, wherein the controller is configured or programmed to change the first coefficient, and the second coefficient or the third coefficient, in response to user operation.

[Item B9] The unmanned aerial vehicle according to any one of Items B1 to B8, wherein a diameter of the at least one second rotor is larger than a diameter of each of the plurality of first rotors.

[Item B10] The unmanned aerial vehicle according to any one of Items B1 to B9, wherein a thrust per revolution of each of the plurality of second rotors is greater than a thrust per revolution of each of the plurality of first rotors.

[Item B11] The unmanned aerial vehicle according to any one of Items B1 to B10, wherein a distance from a center of the body to a rotation axis of each of the plurality of second rotors is shorter than a distance from the center of the body to a rotation axis of each of the plurality of first rotors.

[Item B12] The unmanned aerial vehicle according to any one of Items B1 to B11, further including a plurality of electric motors each to drive a respective one of the plurality of first rotors, and an internal combustion engine to drive the at least one second rotor, wherein the controller is configured or programmed to control rotation of the plurality of first rotors by controlling the plurality of electric motors and control rotation of the at least one second rotor by controlling the internal combustion engine.

[Item B13] A control method performed by a controller in an unmanned aerial vehicle including a plurality of rotors including a plurality of first rotors and at least one second rotor, and the controller configured or programmed to perform attitude control of a body of the vehicle by controlling rotation of the plurality of first rotors and generate a main thrust by controlling rotation of the at least one second rotor, the control method including calculating a first thrust to be generated by the plurality of first rotors, calculating a second thrust to be generated by the at least one second rotor based on the first thrust and a total thrust needed for flight, determining a rotational speed of each of the plurality of first rotors based on the first thrust, and determining a rotational speed of the at least one second rotor based on the second thrust.

[Item C1] An unmanned aerial vehicle including a plurality of electric motors, an internal combustion engine, a plurality of first rotors each driven by a corresponding one of the plurality of electric motors, at least one second rotor driven by the internal combustion engine, and a controller configured or programmed to determine a first rotational speed for each of the plurality of first rotors and a second rotational speed for the at least one second rotor, generate a first control signal to rotate each of the plurality of electric motors based on the first rotational speed for each of the plurality of first rotors, and generate a second control signal to drive the internal combustion engine based on the second rotational speed.

[Item C2] The unmanned aerial vehicle according to Item C1, wherein the controller is configured or programmed to generate the second control signal based on a table to convert the second rotational speed into a rotational speed of the internal combustion engine.

[Item C3] The unmanned aerial vehicle according to Item C1 or C2, wherein the controller is configured or programmed to perform attitude control of a body of the vehicle by controlling rotation of the plurality of first rotors through controlling the plurality of electric motors, and generate a main thrust by controlling rotation of the at least one second rotor through controlling the internal combustion engine.

[Item C4] The unmanned aerial vehicle according to any one of Items C1 to C3, wherein the controller is configured or programmed to generate a first Pulse Width Modulation (PWM) signal with a duty ratio corresponding to the first rotational speed as the first control signal and generate a second PWM signal with a duty ratio corresponding to the second rotational speed of the at least one second rotor, and convert the second PWM signal into the second control signal that determines a rotational speed of the internal combustion engine.

[Item C5] The unmanned aerial vehicle according to Item C4, wherein the controller is configured or programmed to read data from a storage regarding a relationship between the duty ratio of the second PWM signal and a number of revolutions per unit time of the internal combustion engine, determine the number of revolutions based on the data and the second PWM signal, and generate the second control signal based on the number of revolutions.

[Item C6] The unmanned aerial vehicle according to Item C4, wherein the second control signal determines an opening degree of a throttle valve of the internal combustion engine, and the controller is configured or programmed to read data from a storage regarding a relationship between the duty ratio of the second PWM signal and an opening degree of the throttle valve, and convert the second PWM signal into the second control signal based on the data.

[Item C7] The unmanned aerial vehicle according to any one of Items C4 to C6, wherein the controller is configured or programmed to determine a first thrust that is a total thrust to be generated by the plurality of first rotors, and a second thrust that is a total thrust to be generated by the at least one second rotor, generate the first control signal for each of the plurality of first rotors based on the first thrust, and determine the second PWM signal based on the first control signal and the ratio of the second thrust to the first thrust.

[Item C8] The unmanned aerial vehicle according to any one of Items C1 to C7, wherein a diameter of the at least one second rotor is larger than a diameter of each of the plurality of first rotors.

[Item C9] The unmanned aerial vehicle according to any one of Items C1 to C8, wherein a thrust per revolution of each of the plurality of second rotors is greater than a thrust per revolution of each of the plurality of first rotors.

[Item C10] The unmanned aerial vehicle according to any one of Items C1 to C9, wherein a distance from a center of a body of the vehicle to a rotation axis of each of the plurality of second rotors is shorter than a distance from a center of the body to a rotation axis of each of the plurality of first rotors.

[Item C11] A control method performed by a controller in an unmanned aerial vehicle including a plurality of electric motors, an internal combustion engine, a plurality of first rotors each driven by one of the plurality of electric motors, at least one second rotor driven by the internal combustion engine, and the controller, the control method including determining a first rotational speed for each of the plurality of first rotors and a second rotational speed for the at least one second rotor, generating a first control signal to rotate each of the plurality of electric motors based on the first rotational speed, and generating a second control signal to drive the internal combustion engine based on the second rotational speed.

According to example embodiments of unmanned aerial vehicles, control systems and control methods of the present disclosure, it is possible to provide unmanned aerial vehicles suitable for agricultural applications, capable of increasing payload and/or flight duration.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing several examples of rotation drivers to rotate rotors in an unmanned aerial vehicle including a plurality of rotors.

FIG. 1B is a plan view schematically showing one example of a basic configuration of an unmanned aerial vehicle including a plurality of rotors.

FIG. 1C is a side view schematically showing one example of a basic configuration of an unmanned aerial vehicle including a plurality of rotors.

FIG. 1D is a plan view schematically showing another example of a basic configuration of an unmanned aerial vehicle including a plurality of rotors.

FIG. 2A is a block diagram showing a basic configuration example of a battery-driven multicopter.

FIG. 2B is a block diagram showing a basic configuration example of a series hybrid type multicopter.

FIG. 2C is a block diagram showing a basic configuration example of a parallel hybrid type multicopter.

FIG. 3A is a top view schematically showing a multicopter according to an example embodiment of the present invention.

FIG. 3B is a side view schematically showing a multicopter according to an example embodiment of the present invention.

FIG. 4 is a block diagram showing an example of system configuration in a multicopter of an example embodiment of the present invention.

FIG. 5 is a plan view schematically showing a parallel hybrid drive type multicopter.

FIG. 6 is a flowchart showing an example of processing to determine the rotational speed of each sub-rotor and each main rotor.

FIG. 7 is a flowchart showing an outline of the operation of the controller related to rudder control.

FIG. 8 is a flowchart showing an example of a control method for electric motors and internal combustion engine.

FIG. 9 is a block diagram showing an example configuration of a flight controller.

FIG. 10 is a diagram showing an example configuration of a module for generating PWM signals for main rotors.

FIG. 11 is a graph showing an example of time variation of duty sum value of PWM signals for sub-rotors and duty value of PWM signal for main rotors.

FIG. 12 is a diagram showing an example configuration of a main rotor controller.

FIG. 13 is a graph showing an example of the relationship between PWM signal duty ratio and engine rotation speed.

FIG. 14 is a block diagram showing an example of hardware configuration of the controller.

FIG. 15 is a diagram schematically showing an example of a communication network to which the multicopter is connected.

### DETAILED DESCRIPTION OF THE EXAMPLE EMBODIMENTS

Unmanned aerial vehicles each include a plurality of rotors and a rotation driver to rotate the rotors (hereinafter referred to as “propellers”). Hereinafter, such an unmanned aerial vehicle is referred to as a “multicopter”.

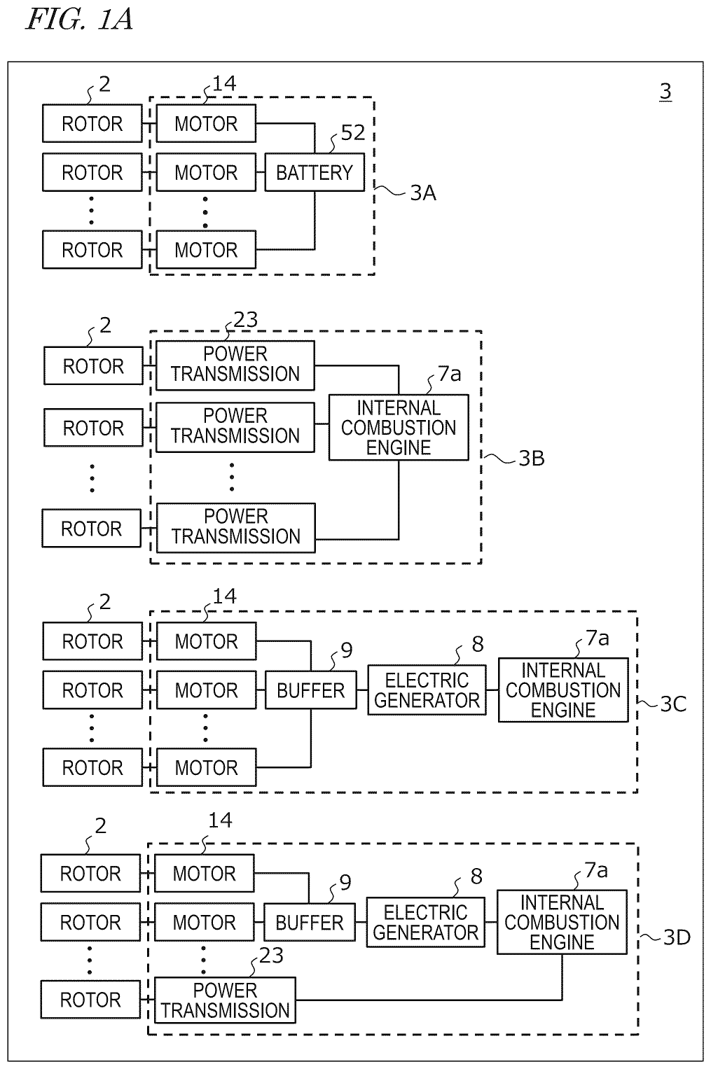

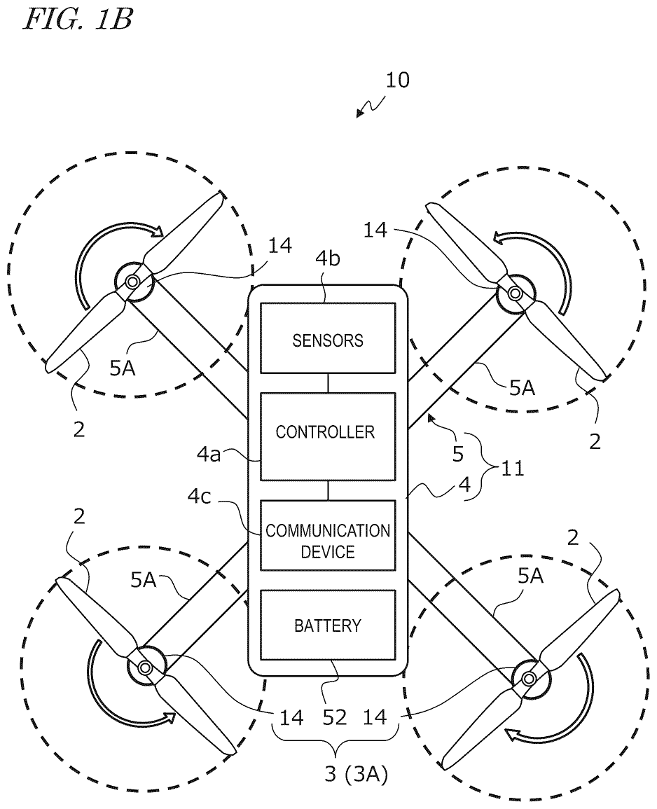

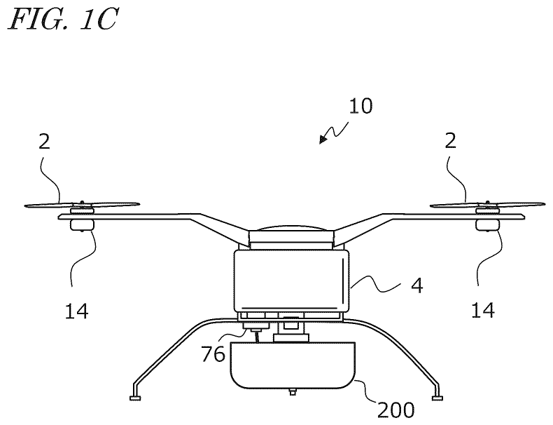

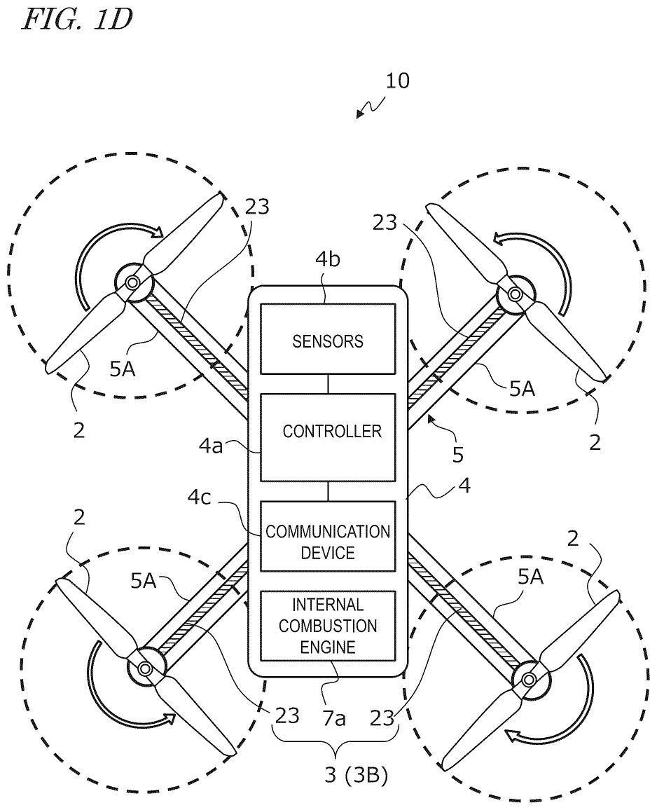

The configuration of rotation drivers included in multicopters exists in various forms. FIG. 1A is a schematic block diagram showing four examples of rotation driver 3 according to example embodiments of the present disclosure.

The first rotation driver 3A shown in FIG. 1A includes a plurality of electric motors (hereinafter referred to as “motors”) 14 that rotate a plurality of rotors 2, and a battery 52 that stores electric power to be supplied to each motor 14. The battery 52 is, for example, a secondary battery such as a polymer-type lithium-ion battery. Each rotor 2 is connected to the output shaft of its corresponding motor 14 and is rotated by the motor 14. To increase payload and/or flight duration, it is necessary to increase the power storage capacity of battery 52. While the power storage capacity of battery 52 can be increased by making battery 52 larger, enlarging battery 52 leads to an increase in weight.

The second rotation driver 3B shown in FIG. 1A includes a power transmission system 23 mechanically connected to rotor 2, and an internal combustion engine 7a that provides driving force (torque) to power transmission system 23. The power transmission system 23 includes mechanical components such as gears or belts and transmits torque from the output shaft of internal combustion engine 7a to rotor 2. The internal combustion engine 7a can efficiently generate mechanical energy through fuel combustion. Examples of internal combustion engine 7a may include gasoline engines, diesel engines, and hydrogen engines. Additionally, the number of internal combustion engines 7a included in rotation driver 3B is not limited to one.

The third rotation driver 3C shown in FIG. 1A includes a plurality of motors 14, a power buffer 9 that stores electric power to be supplied to each motor 14, an electric generator 8 such as an alternator that generates electric power, and an internal combustion engine 7a that provides mechanical energy for power generation to the electric generator 8. While a typical example of power buffer 9 is a battery such as a secondary battery, it may also be a capacitor. In the third rotation driver 3C, even when the power buffer 9 does not have a large power storage capacity, it is possible to increase payload and/or flight duration because the electric generator 8 generates electric power using the driving force (mechanical energy) of internal combustion engine 7a. This type of driver is called a “series hybrid driver”. The electric generator 8 and internal combustion engine 7a in a series hybrid driver are called a “range extender” as they extend the flight distance of the multicopter.

The fourth rotation driver 3D shown in FIG. 1A includes a plurality of motors 14, a power buffer 9 that stores electric power to be supplied to each motor 14, an electric generator 8 such as an alternator that generates electric power, an internal combustion engine 7a that provides driving force to the electric generator 8 for power generation, a power transmission system 23 that transmits driving force generated by the internal combustion engine 7a to the rotor 2 to rotate the rotor 2. At least one rotor 2 of the plurality of rotors 2 is rotated by the internal combustion engine 7a, while other rotors 2 are rotated by the motor 14. In the fourth rotation driver 3D, since mechanical energy generated by internal combustion engine 7a can be utilized for rotor rotation without conversion to electrical energy, energy utilization efficiency can be enhanced. This type of driver is called a “parallel hybrid driver”.

FIG. 1B is a plan view schematically showing a basic configuration example of multicopter 10. In the configuration example of FIG. 1B, a rotation driver 3 includes the first rotation driver 3A shown in FIG. 1A. That is, in this example, rotation driver 3 (3A) includes motors 14 and a battery 52. FIG. 1C is a side view schematically showing the multicopter 10.

A multicopter 10 shown in FIGS. 1B and 1C includes a plurality of rotors 2, a main body 4, and a body frame 5 that supports rotors 2 and main body 4. The body frame 5 supports the main body 4 at its central portion and supports the plurality of rotors 2 rotatably at the plurality of arms 5A extending outward from the central portion. The motors 14 that rotate rotors 2 are provided near the ends of each arm 5A. The main body 4 and body frame 5 may be collectively referred to as “body 11”.

In the example of FIG. 1B, the multicopter 10 is a quad-type multicopter (quadcopter) including four rotors 2. The rotors 2 positioned on the same diagonal line rotate in the same direction (clockwise or counterclockwise), while rotors 2 positioned on different diagonal lines rotate in opposite directions.

The main body 4 includes a controller 4a configured or programmed to control the operation of devices and components mounted on multicopter 10, sensors 4b connected to the controller 4a, a communication device 4c connected to the controller 4a, and a battery 52.

The controller 4a may include, for example, a flight controller such as a flight controller and a higher-level computer (companion computer). The companion computer may perform advanced computational processing such as image processing, obstacle detection, and obstacle avoidance based on sensor data acquired by the sensors 4b.

The sensors 4b may include an acceleration sensor, angular velocity sensor, geomagnetic sensor, atmospheric pressure sensor, altitude sensor, temperature sensor, flow sensor, imaging device, laser sensor, ultrasonic sensor, obstacle contact sensor, and GNSS (Global Navigation Satellite System) receiver. The acceleration sensor and angular velocity sensor may be mounted on the main body 4 as components of an IMU (Inertial Measurement Unit). Examples of laser sensors may include a laser range finder used to measure a distance to the ground, and 2D or 3D LiDAR (light detection and ranging).

The communication device 4c may include a wireless communication module for signal transmission and reception with a ground-based transmitter or ground control station (GCS) via an antenna, and a mobile communication module that utilizes cellular communication networks. The communication device 4c is configured to receive signals such as control commands transmitted from the ground and transmit sensor data such as image data acquired by sensors 4b as telemetry information. The communication device 4c may also include functions for communication between multicopters and satellite communication capabilities. The controller 4a may connect to computers in the cloud through the communication device 4c. The computer in the cloud may execute some or all of the functions of the companion computer.

A battery 52 is a secondary battery that is configured to store electric power through charging and supply electric power to motors 14 through discharging. Through the operation of battery 52 and the plurality of motors 14, a plurality of rotors 2 can be rotationally driven to generate desired thrust.

Each of the plurality of rotors 2 generally includes a plurality of blades with fixed pitch angles and generates thrust through rotation. The pitch angles may be variable. Not all of the plurality of rotors 2 need to have the same diameter (propeller diameter), and one or more rotors 2 may have a larger diameter than other rotors 2. The thrust (static thrust) generated by rotating the rotor 2 is generally proportional to the cube of the rotor's diameter. Therefore, when the rotors 2 of different diameters are included, the rotors 2 with relatively large diameters may be called “main rotors” and the rotors 2 with relatively small diameters may be called “sub-rotors”. Regardless of the size of the diameter, the rotors 2 capable of generating relatively large thrust and the rotors 2 capable of generating relatively small thrust may be included depending on the configuration of rotation driver 3. In such case, the rotors 2 capable of generating relatively large thrust may be called “main rotors” and the rotors 2 capable of generating relatively small thrust may be called “sub-rotors”. For example, the rotors 2 that generate relatively large thrust per revolution may be called “main rotors” and the rotors 2 that generate relatively small thrust per revolution may be called “sub-rotors”. In one example, main rotors may be positioned farther inward than sub-rotors. In other words, the rotors 2 may be positioned such that the distance from the center of the body to the rotation axis of each main rotor is shorter than the distance from the center to the rotation axis of each sub-rotor.

In this example, the rotation driver 3 includes a plurality of motors 14. As mentioned above, the rotation driver 3 may include the internal combustion engine 7a.

FIG. 1D is a plan view schematically showing a basic configuration example of a multicopter 10 including the second rotation driver 3B. In the example shown in FIG. 1D, the internal combustion engine 7a is supported by the main body 4. In this example, the driving force generated by internal combustion engine 7a is transmitted to the plurality of rotors 2 through a plurality of power transmission systems 23 to rotate each rotor 2. The controller 4a may change the rotational speed of individual rotors 2 by controlling each power transmission system 23. Rotation driver 3B may include a mechanism for changing the pitch angle of blades of each of the plurality of rotors 2. In that case, the controller 4a may adjust the lift generated by each rotor 2 by controlling that mechanism to change the blade pitch angles.

In a “parallel hybrid driver” where some of the plurality of rotors 2 are rotated by the internal combustion engine 7a and other rotors 2 are rotated by the motors 14, the internal combustion engine 7a and battery 52 are supported by the main body 4. At least one of the plurality of rotors 2 is connected to the internal combustion engine 7a through the power transmission system 23, and other rotors 2 are connected to the motors 14.

In such a parallel hybrid driver, the diameter of one or more rotors 2 rotated by the internal combustion engine 7a may be larger than the diameter of other rotors 2 rotated by the motors 14. In other words, the internal combustion engine 7a may be used for rotating the main rotors and the motors 14 may be used for rotating the sub-rotors. In such case, the main rotors are mainly used for generating thrust, and the sub-rotors are used for both generating thrust and attitude control. The main rotors may be called “booster rotors” and the sub-rotors may be called “attitude control rotors”.

In the parallel hybrid driver, the internal combustion engine is used for both thrust generation and power generation. By selectively transmitting driving force (torque) generated by the internal combustion engine to either or both of the rotor and electric generator, it is possible to achieve balanced thrust generation and power generation.

When a multicopter includes an internal combustion engine and uses the internal combustion engine for at least one of thrust generation and power generation, this contributes to increased payload and flight duration. It is desirable to perform attitude control of the multicopter by rotating propellers using motors, which have superior response characteristics compared to internal combustion engines. Therefore, in applications where accurate attitude control of the multicopter is required, it is desirable to adopt a parallel hybrid driver or a series hybrid driver to increase payload and flight duration. Note that when the rotation driver 3 includes a mechanism for changing the pitch angle of blades of each of the plurality of the rotors 2, the attitude can also be adjusted by changing the pitch angle of each blade.

Through increased payload and flight duration, the applications of multicopters can be further expanded. For example, in the agricultural field, multicopters are currently being used for agricultural chemical spraying or crop growth monitoring. Various agricultural work can be performed from the air by connecting various ground work machines (hereinafter may be simply referred to as “work machines”) to the multicopter. Agricultural work machines are sometimes referred to as “implements”. Examples of implements may include sprayers for spraying chemicals on crops, mowers, seeders, spreaders (fertilizer applicators), rakes, balers, harvesters, plows, harrows, or rotary tillers. Work vehicles such as tractors are not included in “implements” in this disclosure.

In the example shown in FIG. 1C, an implement 200 capable of dispersing substances such as agricultural chemicals or fertilizers onto a field or crops in the field is connected to multicopter 10. Increased payload and flight duration enable the implement 200 to achieve a larger size and/or multi-functionality. For example, by changing the implement 200 connected to multicopter 10, various ground operations (agricultural work) including liquid application, granular application, fertilization, thinning, weeding, transplanting, direct seeding, and harvesting can be performed. The implement 200 may be including mechanisms such as robotic hands. In that case, a single implement 200 can perform various ground operations. When the implement 200 includes space large enough to store materials, the implement 200 can also transport agricultural materials or harvested crops over a wide area. There are various forms of connecting the implement 200 to the multicopter 10. The multicopter 10 may suspend and tow the implement 200 using a cable. The implement 200 towed by the multicopter 10 can perform ground operations while being towed during flight or hovering of multicopter 10. The implement 200 during operation may be in the air or on the ground.

In the example shown in FIG. 1C, the multicopter 10 includes power supply 76. The power supply 76 is a device that supplies power to the implement 200 from driving energy sources such as a battery 52 or an electric generator 8 included in the multicopter 10. Various functions of the implement 200 may be performed using this power. The implement 200 includes actuators such as motors that operate using power obtained from the power supply 76 of the multicopter 10. The implement 200 preferably includes a battery for storing power.

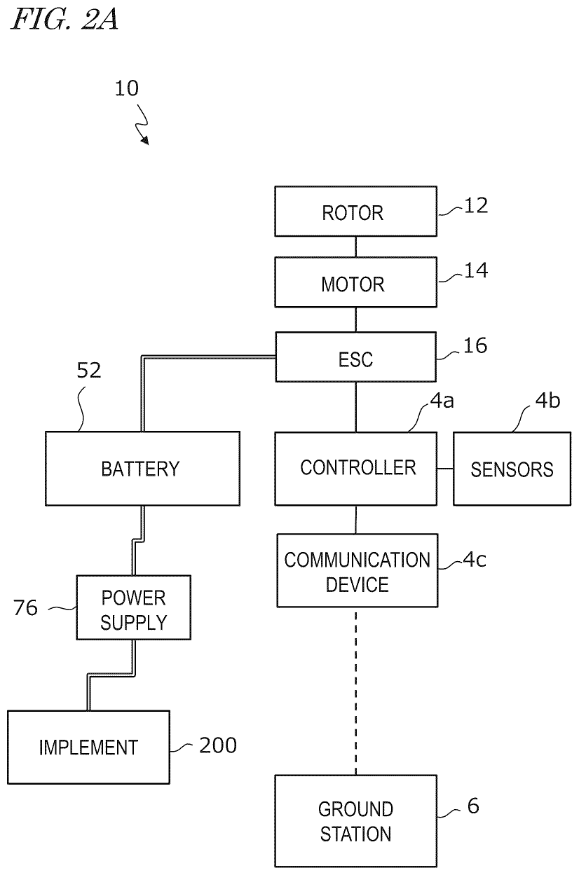

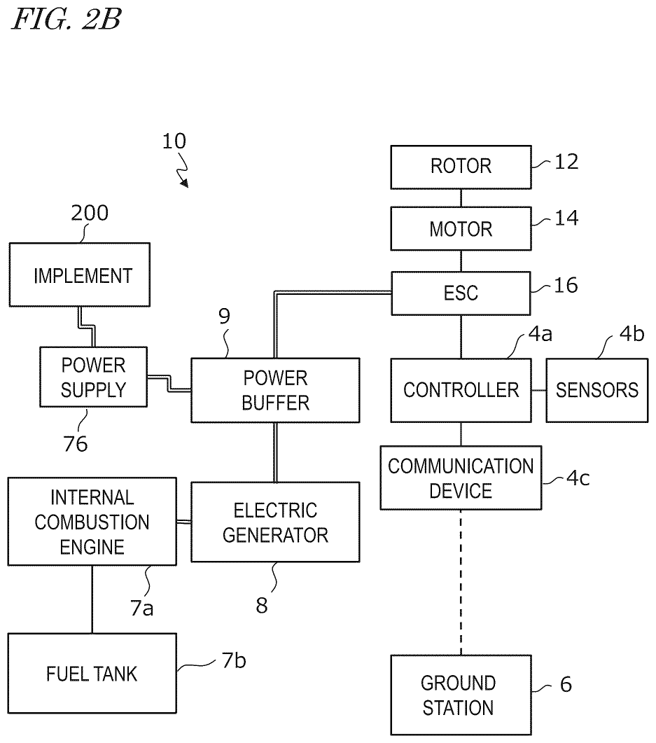

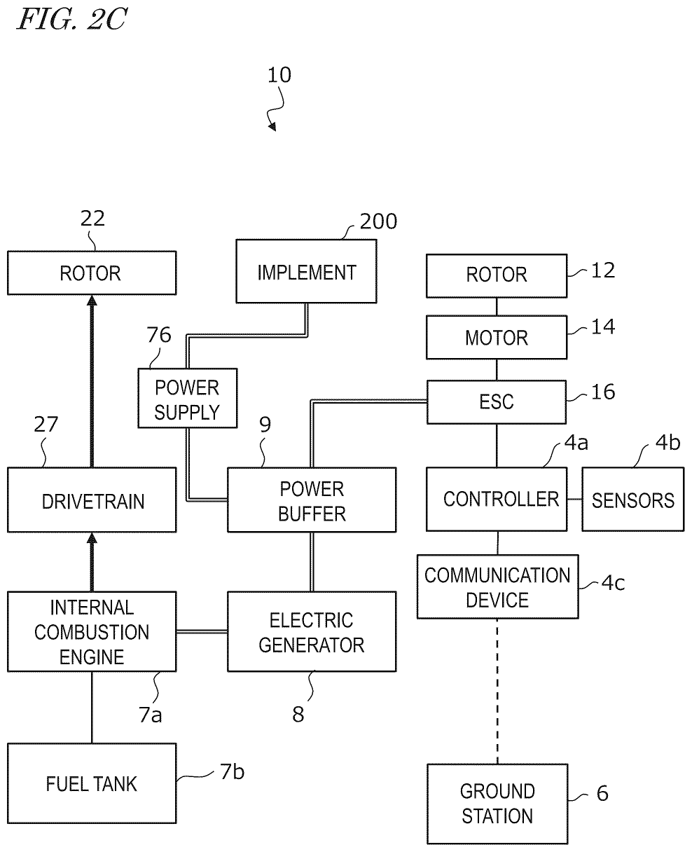

FIG. 2A shows a block diagram of a basic configuration example of a battery-driven multicopter 10. The battery-driven multicopter 10 includes a plurality of rotors 12, a plurality of motors 14, each driving a respective one of the plurality of rotors 12, a plurality of ESCs (Electric Speed Controllers) 16 each including a motor drive circuit that drives a respective one of the plurality of motors 14, a battery 52 that supplies power to each of the plurality of motors 14 through each respective ESC 16, a controller 4a configured or programmed to control a plurality of ESCs 16 to control attitude while flying, sensors 4b, a communication device 4c, and a power supply 76 that is electrically connected to the battery 52. In FIG. 2A, for simplicity, the rotor 12, the motor 14, and the ESC 16 are each shown by a single block, but the numbers of rotors 12, motors 14, and ESCs 16 are each plural. This also applies to FIGS. 2B and 2C. The ESC 16 may be included in the controller 4a.

The controller 4a may receive control commands wirelessly from, for example, a ground station 6 on the ground through the communication device 4c. The number of ground stations 6 is not limited to one, and the grand station 6 may be distributed across a plurality of locations. The communication device 4c may also wirelessly receive control commands from an operator's controller on the ground. The controller 4a may have functions to automatically or autonomously execute takeoff, flight, obstacle avoidance, and landing operations based on sensor data obtained from the sensors 4b. The controller 4a may be configured or programmed to communicate with the implement 200 connected to the power supply 76 and obtain signals indicating the state of the implement 200 from the implement 200. Additionally, the controller 4a may provide signals to control the operation of the implement 200. Furthermore, the implement 200 may generate signals to instruct the operation of multicopter 10 and transmit them to the controller 4a. Such communication between the controller 4a and the implement 200 may be conducted through wired or wireless means.

FIG. 2B is a block diagram showing a basic configuration example of a series hybrid drive type multicopter 10. Like the battery-driven multicopter 10, the series hybrid drive type multicopter 10 includes a plurality of rotors 12, a plurality of motors 14, a plurality of ESCs 16, a controller 4a, sensors 4b, and a communication device 4c. The series hybrid drive type multicopter 10 shown in the figure further includes an internal combustion engine 7a, a fuel tank 7b that stores fuel for the internal combustion engine 7a, an electric generator 8 that is driven by the internal combustion engine 7a to generate electric power, a power buffer 9 that temporarily stores electric power generated by the electric generator 8, and a power supply 76 that is electrically connected to the power buffer 9. The power buffer 9 is, for example, a battery such as a secondary battery. Electric power generated by the electric generator 8 is supplied to the motors 14 through the power buffer 9 and the ESCs 16. Additionally, the electric power generated by the electric generator 8 may be supplied to the implement 200 through the power supply 76.

FIG. 2C is a block diagram showing a basic configuration example of a parallel hybrid drive type multicopter 10. Like the series hybrid drive type multicopter 10, the parallel hybrid drive type multicopter 10 includes a plurality of rotors 12, a plurality of motors 14, each driving a respective one of the plurality of rotors 12, a plurality of ESCs 16, a controller 4a, sensors 4b, a communication device 4c, an internal combustion engine 7a, a fuel tank 7b, an electric generator 8, a power buffer 9, and a power supply 76. The parallel hybrid drive type multicopter 10 further includes a drivetrain 27 that transmits driving force from the internal combustion engine 7a, and the rotor 22 that rotates upon the receiving driving force from the internal combustion engine 7a through the drivetrain 27. The rotor 12 and rotor 22 may be distinguished by calling one “first rotor” and the other “second rotor”. The number of rotors 22 connected to drivetrain 27 and rotated may be one or two or more.

In the parallel hybrid drive type multicopter 10, the internal combustion engine 7a not only drives the electric generator 8 to generate power, but also mechanically transmits energy to the rotor 22 to rotate the rotor 22. In contrast, in the series hybrid drive type multicopter 10, all rotors 12 are rotated by electric power generated by the electric generator 8. Therefore, in the series hybrid drive type multicopter 10, when the electric generator 8 is, for example, a fuel cell, the internal combustion engine 7a is not an essential component.

The following describes configuration examples and operation examples of unmanned aerial vehicles according to example embodiments of the present disclosure, taking a parallel hybrid drive multicopter as an example.

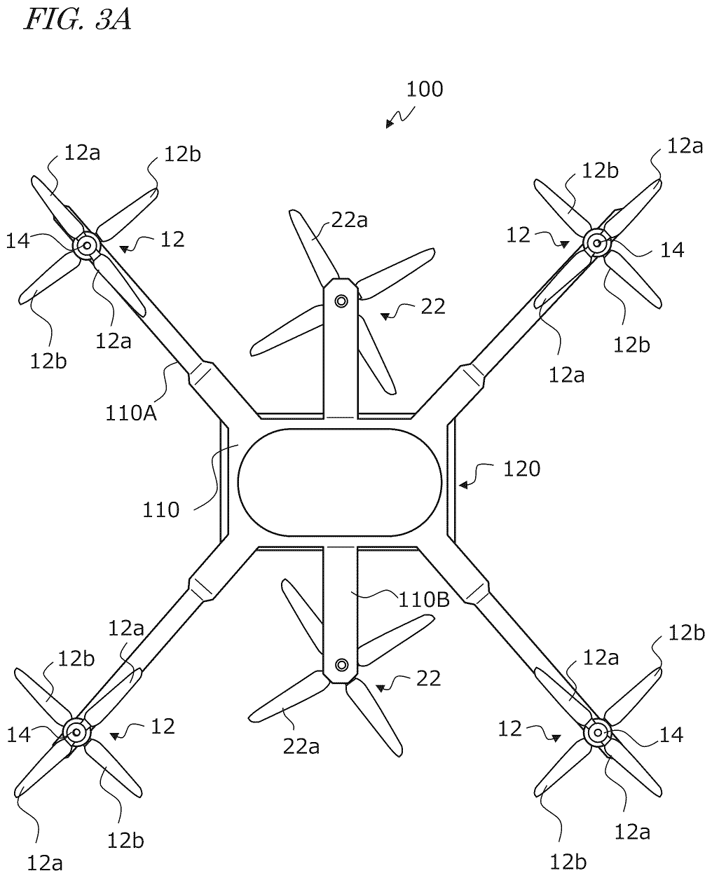

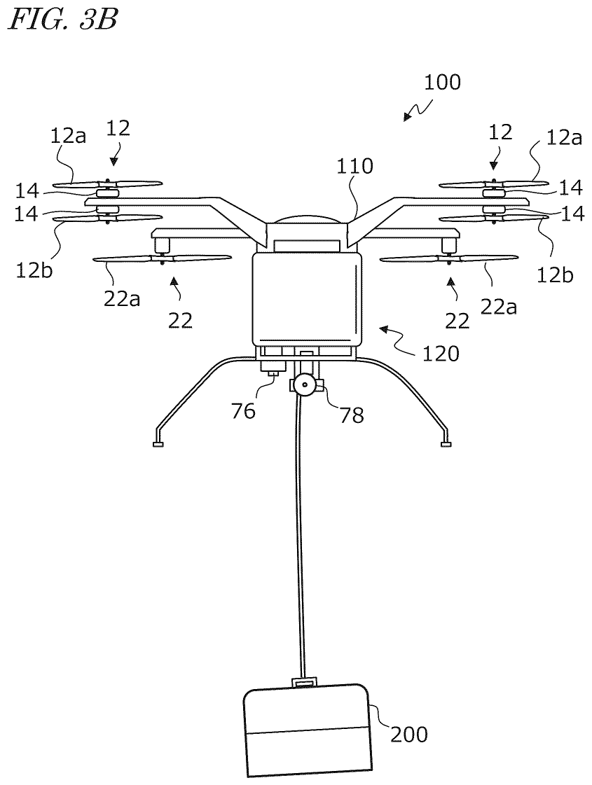

FIG. 3A is a top view schematically showing a multicopter 100 according to the present example embodiment, and FIG. 3B is a side view thereof. In FIG. 3B, an implement 200 connected to the multicopter 100 is shown. The multicopter 100 may be connected with cargo, agricultural materials, other machinery, or containers, cases, or packages capable of accommodating them, together with or in place of the implement 200. Hereinafter, the weight of the implement 200 and the implement itself may be referred to as “payload”. The “coupling” between the multicopter 100 and the implement 200 or the like may be made by various devices or apparatuses.

The multicopter 100 shown in FIG. 3A includes eight sub-rotors 12 and two main rotors 22, for example. The sub-rotors 12 include four sets of propellers 12a and 12b that rotate in opposite directions on the same axis, for example. Each of propellers 12a and 12b includes two blades, for example. The propellers 12a, 12b are each rotated by motors 14. The four sets of propellers 12a and 12b rotating in opposite directions on the same axis are located at vertices of a quadrilateral, for example. The main rotors 22 include two propellers 22a rotating in opposite directions at different positions. Each propeller 22a includes four blades, for example. The eight propellers 12a, 12b of sub-rotor 12 have the same pitch angle and diameter. The two propellers 22a of main rotor 22 also have the same pitch angle and diameter, for example. The diameter of propeller 22a is about 1.2 times or more, for example, about 1.4 times or more and about 2.0 times or less, than the diameter of propellers 12a and 12b.

The multicopter 100 includes a body frame 110 including four arms 110A for the sub-rotors 12 and two arms 110B for the main rotors 22, for example. The body frame 110 supports a main body 120 including various electronic components and mechanical components described later.

In the example of FIG. 3B, the main body 120 includes a power supply 76 and an actuator 78 used to connect to the implement 200 and other purposes. The power supply 76 supplies power generated within the main body 120 to the implement 200. The actuator 78 is a device such as an electric motor that performs operations to connect the implement 200 to the main body 120 of the multicopter 100. In the example of FIG. 3B, the actuator 78 drives a mechanism for winding up a cable connecting the main body 120 and the implement 200. This cable may include a power line to supply power to the implement 200 from the multicopter 100, and a communication line to enable communication between the multicopter 100 and the implement 200.

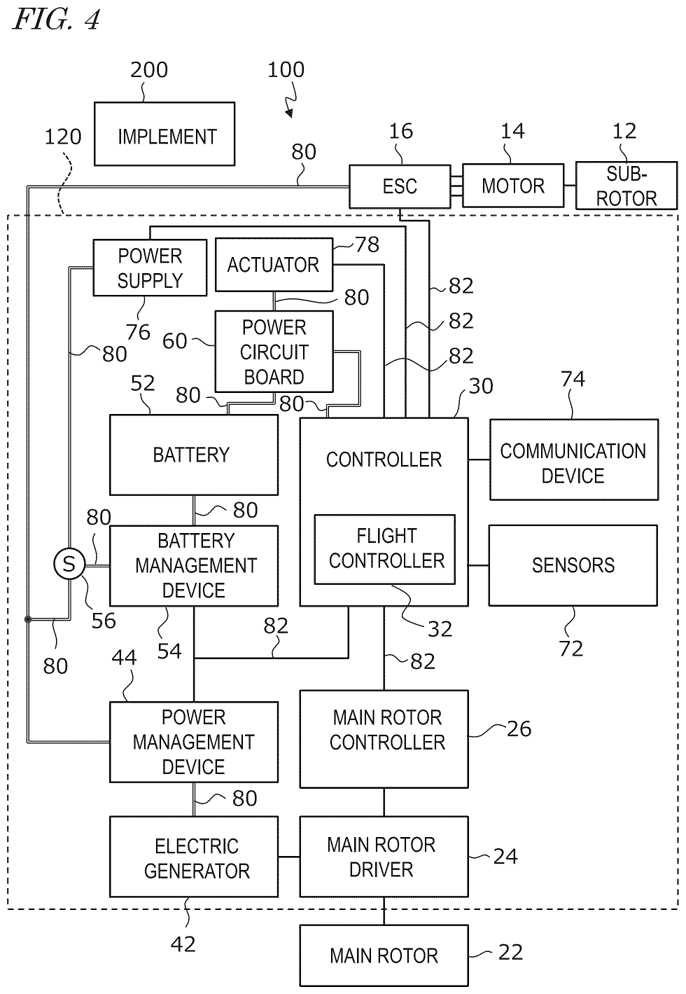

FIG. 4 is a block diagram showing an example of the system configuration of the multicopter 100 according to the present example embodiment.

In the illustrated example, the main body 120 of the multicopter 100 includes a controller 30 including a flight controller 32, sensors 72, and a communication device 74. These are basically similar to the controller 4a, sensors 4b, and communication device 4c included in the main body 4 of the multicopter 10 explained with reference to FIG. 1A.

The multicopter 100 according to the present example embodiment includes eight sub-rotors 12, eight motors 14 that respectively rotate the eight sub-rotors 12, and eight ESCs that respectively control the eight motors 14, for example. Each ESC 16 receives a motor control signal to control the motor 14 from the controller 30 via wiring 82. The motor control signal is, for example, a PWM (Pulse Width Modulation) signal. When the motor control signal is a PWM signal, the duty cycle of the PWM signal may indicate an analog value of the motor rotation speed. Each ESC 16 controls the rotation speed of the motor 14 connected to that ESC 16 based on the motor control signal from the controller 30. In FIG. 4, for simplicity, one set of “sub-rotor 12, motor 14 and ESC 16” is shown, but the multicopter 100 according to the present example embodiment includes eight sets of “sub-rotor 12, motor 14 and ESC 16”, for example. The number of these sets is not limited to eight.

The controller 30 is connected to individual ESCs 16 via electrically independent wiring 82 and may individually control each of the eight ESCs 16. As mentioned earlier, the sub-rotor 12 is used not only for generating lift but also for attitude control. Attitude control is achieved by the flight controller 32 of the controller 30 obtaining measured or estimated values indicating the attitude of the main body 120 from the sensors 72 to determine the current attitude of the main body 120, and controlling the rotation speed of individual motors 14 according to the difference from the target attitude.

The main body 120 includes a main rotor driver 24 that drives the main rotor 22 and a main rotor controller 26 that controls the main rotor driver 24. In this example embodiment, the main rotor driver 24 is an internal combustion engine. Therefore, the main rotor controller 26 includes an Engine Control Unit (ECU). The main rotor controller 26 is configured or programmed to execute control of the internal combustion engine by acquiring sensor data such as throttle opening, intake temperature, engine speed, and temperature of various portions of the main rotor driver 24, which is an internal combustion engine. The main rotor controller 26 is connected to the controller 30 via wiring 82 such as a CAN (Controller Area Network) bus. The main rotor controller 26 is configured or programmed to output engine control signals based on signals transmitted from the controller 30. The engine control signal includes, for example, throttle opening. A digital-to-analog converter (DAC) and/or voltage converter may be connected between the controller 30 and the main rotor controller 26. Mechanical devices such as a clutch and reduction gear may be provided between the main rotor driver 24 and the main rotor 22.

The main rotor driver 24 preferably is an internal combustion engine with minimal vibration. In this example embodiment, the main rotor driver 24 is, for example, an opposed piston engine. The opposed piston engine is disclosed in, for example, Japanese Patent No. 5508604. The entire contents of Japanese Patent No. 5508604 are hereby incorporated by reference.

The main rotor driver 24, which is an internal combustion engine, may drive an electric generator 42 such as an alternator to generate power. In this example embodiment, the electric generator 42 has the structure of an AC synchronous motor including a rotor and a stator. Therefore, the electric generator 42 may also function as a “starter” by rotating the rotor through energization during startup of the main rotor driver 24. The electric generator 42 rectifies the alternating current generated by power generation to convert it to direct current. The electric generator 42 generates direct current power required for driving the motor 14 and supplies it to each ESC 16 via wiring 80. The electric generator 42 is configured to output, for example, a direct current voltage of 250V or higher. Note that the wiring 80 is power wiring, and the wiring 82 is signal wiring. Each of wirings 80 and 82 includes a plurality of conductors.

The electric generator 42 is connected to a power management device 44. The power management device 44 is connected to the controller 30 and a battery management device 54 to be described later. The power management device 44 may control the amount of power generation by the electric generator 42 based on signals from the controller 30 or the battery management device 54. This amount of power generation may be variably controlled by the power management device 44 according to the power required by the motor 14 and battery 52, even when the engine speed of the main rotor driver 24, which is an internal combustion engine, is in a constant state.

The main body 120 further includes a battery 52 including a plurality of cells of, for example, lithium-ion secondary batteries connected in series or parallel, and a battery management device 54 that controls charging and discharging of the battery 52.

The battery 52 may receive direct current power from the electric generator 42 via a power switch 56 and be charged by that power. The operation of the power switch 56 may be controlled by the battery management device 54 and the controller 30. The battery management device 54 measures or estimates parameter values defining the state of battery 52, such as current flowing through battery 52, cell voltage, cell balance, State Of Charge (SOC), State Of Health (SOH), and temperature.

The battery management device 54 may control the power switch 56 according to the state of the battery 52. For example, when the battery 52 is in a state requiring charging, the battery management device 54 electrically connects the electric generator 42 and battery 52 via the power switch 56, and supplies power from the electric generator 42 to the battery 52 to execute charging operation. At this time, the battery management device 54 may control the power management device 44 and increase the amount of power generation by the electric generator 42 so that the power supplied to ESC 16 does not fall below a desired level. In contrast, when the battery 52 is in a state not requiring charging, the battery management device 54 disconnects the electrical connection between the electric generator 42 and battery 52 by the power switch 56 to stop the charging of the battery 52.

In this example embodiment, the battery 52 has a power storage capacity that allows, even when power generation by the electric generator 42 stops for some reason and lift from the main rotor 22 is lost, continued generation of lift and attitude control by the sub-rotor 12 to fly to a location where landing is possible and land there. In other words, when the multicopter 100 according to this example embodiment is flying normally, the power required to drive the sub-rotor 12 can be supplied to ESC 16 from the electric generator 42 rather than from the battery 52. Therefore, even when increasing payload and flight duration, there is little need to increase the power storage capacity of battery 52 accordingly.

The power stored in battery 52 may be output as, for example, a direct current voltage of 250V or higher. However, this direct current voltage decreases with decreasing state of charge. Therefore, when the state of charge falls below a predetermined level, the battery management device 54 operates to supply a portion of the direct current power from the electric generator 42 to battery 52 to charge battery 52.

The battery 52 is connected to a power circuit board 60. The power circuit board 60 has the function of stepping down the voltage output from battery 52 to, for example, 24V, 12V, and 5V. The direct current voltage output from battery 52 is converted to a desired voltage by the power circuit board 60 before being supplied to other electronic components. In the example of FIG. 4, power stepped down by the power circuit board 60 is supplied to the controller 30 and actuator 78 via wiring 80.

In the example of FIG. 4, the power supply 76 is electrically connected to the electric generator 42 or battery 52 via the power switch 56. The power supply 76 in this example is configured to supply power generated within the main body 120 to external machines or devices such as the implement 200.

The main body 120 may have configurations not shown in FIG. 4. For example, the main body 120 may include a fuel tank for storing fuel required for operation of the main rotor driver 24, water-cooled or air-cooled devices for cooling the main rotor driver 24, and electrical equipment such as lighting devices and electric pumps. The electrical equipment may operate on power stepped down to a predetermined voltage by the power circuit board 60. Additionally, a battery (auxiliary battery) for electrical equipment may be provided and configured to supply power to the electrical equipment. Such an auxiliary battery may be charged from the battery 52 or the electric generator 42.

In this example embodiment, the motor 14 functions as a plurality of “attitude controllers” that respectively drive a plurality of first rotors (sub-rotors) 12. Additionally, the main rotor driver 24, which is an internal combustion engine, functions as a “main thrust generating device” that drives the second rotor (main rotor) 22.

In the example shown in FIG. 4, the controller 30 and the main rotor controller 26 are separate components, but a single controller (computer or ECU) may be configured or programmed to perform the functions of the controller 30 and the main rotor controller 26.

In this example embodiment, the controller 30 can vary the ratio (thrust ratio) between the total thrust from the sub-rotors 12 obtained from the plurality of motors 14 (first thrust) and the total thrust from the main rotors 22 obtained from the main rotor driver 24 (second thrust). This point will be explained in detail below.

Generally, the responsiveness of motor 14 is superior to that of internal combustion engines. Regarding the torque required for rotation of rotors 12 and 22, when the time from the input of a torque command signal to the achievement of the torque target value is called the “response time”, the response time of motors is, for example, about 1/100 of that of internal combustion engines. Therefore, to control the attitude of the multicopter 100, it is desirable to detect the difference between the current value and target value of the attitude angle of the multicopter 100, and control the rotation speed of each of the plurality of sub-rotors 12 with high response speed to reduce this difference. An increase in rotor rotation speed generates an increase in thrust. By adjusting the thrust of each of the plurality of sub-rotors 12, it is possible to control the attitude of the multicopter 100 with high precision and quickly.

In contrast, internal combustion engines efficiently generate large thrust. While the rotation of sub-rotor 12 is performed using power generated by the power of the main rotor driver 24, which is an internal combustion engine, energy loss occurs when converting mechanical energy to electrical energy. Therefore, from the viewpoint of improving energy consumption efficiency, it is preferable that the main rotor driver 24 be used for main thrust generation by rotating the main rotor 22. Additionally, to increase the thrust of main rotor 22, it is preferable that the diameter of each main rotor 22 be larger than the diameter of each of the plurality of sub-rotors 12.

However, when the main rotor 22 for main thrust generation is generating large thrust, that large thrust and rotational moment may, conversely, inhibit the attitude control function of the sub-rotors 12. As a result, even when using the plurality of motors 14 with superior responsiveness to rotate the plurality of sub-rotors 12, delays in attitude control response may occur. In contrast, while lowering the rotation speed of the main rotor 22 improves attitude control performance, energy consumption efficiency decreases.

In battery-powered multicopters, various algorithms are used to adjust the torque of each of the plurality of motors to balance the thrust of each rotor and control to a desired attitude. When performing attitude control with the plurality of motors in such case, adding a rotor rotated by an internal combustion engine may complicate the calculations needed for attitude control. To avoid such complications, it is effective to fix the “ratio” between the drive power output from the plurality of motors and the drive power output from the internal combustion engine. Therefore, in conventional parallel hybrid types, a control method that fixes this ratio has been adopted.

However, as a result of studies by the present inventors, it was discovered that when using the multicopter 100 for agricultural work, for example, it is preferable to make the above “ratio” variable rather than fixed, compared to when flying the multicopter 100 for simple logistics or surveillance purposes. This is because when flying for agricultural purposes, the multicopter 100 operates under various different conditions, such as various agricultural work (ground work) within fields, movement between a plurality of fields, and transport of agricultural materials or harvested crops, and due to these conditions, the required response speed level for attitude control changes significantly. Additionally, when connecting implements with diverse weights and shapes selected according to the content of agricultural work, the required lift and precision of attitude control may also change significantly.

In this example embodiment, when precise attitude control is not required, for example, when there are few disturbances such as wind, the payload is small, or when only moving without performing work with the implement, the thrust of the main rotor 22 can be increased, and instead, the thrust of the sub-rotors 12 can be reduced.

On the other hand, when precise attitude control is required, for example, when performing ground work while flying with an implement connected, or when a more responsive change in attitude of the main body is required than in normal flight, it is preferable to reduce the thrust of the main rotor 22 (or eliminate it) and instead increase the thrust of the sub-rotors 12. While such a reduction in main rotor thrust may lead to a decrease in overall energy consumption efficiency, it enables an improvement in attitude control performance (response performance).

Next, an example method for determining the rotational speeds of each main rotor 22 and each sub-rotor 12 will be explained.

FIG. 5 is a plan view schematically showing a parallel hybrid drive type multicopter 100. FIG. 5 shows an xyz coordinate system defined by mutually orthogonal x-axis, y-axis, and z-axis. This coordinate system is fixed to the aircraft body, and its origin is located at the center (e.g., center of gravity) of the body. The x-axis extends in the forward direction of the aircraft and is also called the “roll axis”. The y-axis extends in the leftward direction of the aircraft and is also called the “pitch axis”. The z-axis extends in the upward direction of the aircraft and is also called the “yaw axis”.

The multicopter 100 shown in FIG. 5 includes two main rotors 22 and eight sub-rotors 12. The two main rotors 22 are supported by two arms 110B1, 110B2 extending along the x-axis. The two main rotors 22 are controlled to rotate in opposite directions to each other. The eight sub-rotors 12 are configured as four pairs of sub-rotors 12, with each pair consisting of two coaxial sub-rotors 12. The four pairs of sub-rotors 12 are supported by four arms 110A1, 110A2, 110A3, 110A4 that make 45-degree angles with the x-axis and y-axis. The two sub-rotors 12 in each pair are controlled to rotate in opposite directions to each other. The distance from the center of the aircraft to the rotation axis of each main rotor 22 is shorter than the distance from the center of the aircraft to the rotation axis of each sub-rotor 12. The diameter of each main rotor 22 is larger than the diameter of each sub-rotor 12. In FIG. 5, each main rotor 22 is represented by a relatively large circle, and each pair of two coaxial sub-rotors 12 is represented by a relatively small circle. Let the magnitudes of the rotational speeds of the four sub-rotors 12 positioned on the upper side (z-axis positive direction) be ω₁, ω₂, ω₃, ω₄, and let the magnitudes of the rotational speeds of the four sub-rotors 12 positioned on the lower side (z-axis negative direction) be ω₅, ω₆, ω₇, ω₈. Also, let the magnitudes of the rotational speeds of the two main rotors 22 be ωₘ₁, ωₘ₂. Here, “rotational speed” refers to the number of revolutions per unit time (e.g., unit: rpm) or angular velocity (e.g., unit: rad/s).

Of the two sub-rotors 12 supported by the upper right arm 110A1 in FIG. 5, the sub-rotor 12 on the z-axis positive direction (upper side) rotates clockwise at rotational speed ω₁, and the sub-rotor 12 on the z-axis negative direction (lower side) rotates counterclockwise at rotational speed ω₅. Of the two sub-rotors 12 supported by the lower right arm 110A2, the sub-rotor 12 on the z-axis positive direction rotates counterclockwise at rotational speed ω₂, and the sub-rotor 12 on the z-axis negative direction rotates clockwise at rotational speed ω₆. Of the two sub-rotors 12 supported by the lower left arm 110A3, the sub-rotor 12 on the z-axis positive direction rotates clockwise at rotational speed ω₃, and the sub-rotor 12 on the z-axis negative direction rotates counterclockwise at rotational speed ω₇. Of the two sub-rotors 12 supported by the upper left arm 110A4, the sub-rotor 12 on the z-axis positive direction rotates counterclockwise at rotational speed ω₄, and the sub-rotor 12 on the z-axis negative direction rotates clockwise at rotational speed ω₈. The main rotor 22 supported by arm 1101B1 extending from the center of the aircraft in the positive x-axis direction rotates clockwise at rotational speed ωₘ₁. The main rotor 22 supported by arm 110B2 extending from the center of the aircraft in the negative x-axis direction rotates counterclockwise at rotational speed ωₘ₂.

Let the length of each of the four arms 110A1, 110A2, 110A3, 110A4 supporting the sub-rotors 12 be I, and the length of each of the two arms 110B1, 110B2 supporting the main rotors 22 be Iₘ. Also, let the total thrust generated by the rotation of the multiple main rotors 22 and multiple sub-rotors 12 be T, the torque for rotation around the x-axis be τ_{φ}, the torque for rotation around the y-axis be τ_{θ}, and the torque for rotation around the z-axis be τ_{ψ}.

The relationship between the total thrust T and torques τ_{φ}, τ_{θ}, τ_{ψ}, and the rotational speeds of the sub-rotors 12 ω₁, ω₂, ω₃, ω₄, ω₅, ω₆, ω₇, ω₈ and the rotational speeds of the main rotors 22 ωₘ₁, ωₘ₂ is expressed by the following Equation 1.

$$( \begin{matrix}T \\ {τ}_{ϕ} \\ {τ}_{θ} \\ {τ}_{ψ}\end{matrix} ) = ( \begin{matrix}{k}_{m} & {k}_{m} & k & k & k & k & k & k & k & k \\ 0 & 0 & - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} \\ - {k}_{m} {l}_{m} & {k}_{m} {l}_{m} & - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} \\ {b}_{m} & - {b}_{m} & b & - b & b & - b & - b & b & - b & b\end{matrix} ) ( \begin{matrix}{{ω}_{m 1}}^{2} \\ {{ω}_{m 2}}^{2} \\ {{ω}_{1}}^{2} \\ {{ω}_{2}}^{2} \\ {{ω}_{3}}^{2} \\ {{ω}_{4}}^{2} \\ {{ω}_{5}}^{2} \\ {{ω}_{6}}^{2} \\ {{ω}_{7}}^{2} \\ {{ω}_{8}}^{2}\end{matrix} ) \qquad Equation 1$$

Here, k, kₘ, b, bₘ are predetermined coefficients. Coefficients k, kₘ, b, bₘ are fixed values determined by the size, shape, and arrangement, etc., of the sub-rotors 12 and main rotors 22, and are stored in a storage device in advance. Note that the relationship shown in Equation 1 is merely illustrative, and a different relationship equation may apply when adopting a configuration different from that shown in FIG. 5. Here, an example where Equation 1 holds is explained.

By separating the terms related to the main rotors 22 and the terms related to the sub-rotors 12 in the right side of Equation 1, the following Equation 2 is obtained.

$$( \begin{matrix}T \\ {τ}_{ϕ} \\ {τ}_{θ} \\ {τ}_{ψ}\end{matrix} ) = ( \begin{matrix}{k}_{m} ( {{ω}_{m 1}}^{2} + {{ω}_{m 2}}^{2} ) \\ 0 \\ {k}_{m} {l}_{m} ( - {{ω}_{m 1}}^{2} + {{ω}_{m 2}}^{2} ) \\ {b}_{m} ( {{ω}_{m 1}}^{2} - {{ω}_{m 2}}^{2} )\end{matrix} ) + ( \begin{matrix}k & k & k & k & k & k & k & k \\ - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} \\ - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} \\ b & - b & b & - b & - b & b & - b & b\end{matrix} ) ( \begin{matrix}{{ω}_{1}}^{2} \\ {{ω}_{2}}^{2} \\ {{ω}_{3}}^{2} \\ {{ω}_{4}}^{2} \\ {{ω}_{5}}^{2} \\ {{ω}_{6}}^{2} \\ {{ω}_{7}}^{2} \\ {{ω}_{8}}^{2}\end{matrix} ) \qquad Equation 2$$

In this example embodiment, the two main rotors 22 are controlled to rotate synchronously in opposite directions. Therefore, we can set ωₘ₁=ωₘ₂=ωₘ. This causes the components of the torques τ_{θ} and τ_{ψ}, attributable to the main rotors 22 to cancel each other out, leaving only the thrust component as the contribution from the main rotors 22. Therefore, Equation 2 is transformed as follows.

$$( \begin{matrix}T - 2 {k}_{m} {{ω}_{m}}^{2} \\ {τ}_{ϕ} \\ {τ}_{θ} \\ {τ}_{ψ}\end{matrix} ) = ( \begin{matrix}k & k & k & k & k & k & k & k \\ - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} \\ - \frac{\sqrt{2} lk}{2} & \frac{\sqrt{2} lk}{2} & \frac{\sqrt{2} lk}{2} & - \frac{\sqrt{2} lk}{2} & - \frac{\sqrt{2} lk}{2} & \frac{\sqrt{2} lk}{2} & \frac{\sqrt{2} lk}{2} & - \frac{\sqrt{2} lk}{2} \\ b & - b & b & - b & - b & b & - b & b\end{matrix} ) ( \begin{matrix}{{ω}_{1}}^{2} \\ {{ω}_{2}}^{2} \\ {{ω}_{3}}^{2} \\ {{ω}_{4}}^{2} \\ {{ω}_{5}}^{2} \\ {{ω}_{6}}^{2} \\ {{ω}_{7}}^{2} \\ {{ω}_{8}}^{2}\end{matrix} ) \qquad Equation 3$$

By acting the inverse matrix of the matrix in the right side of Equation 3 on both sides from the left, the following relationship in Equation 4 is obtained.

$$( \begin{matrix}{{ω}_{1}}^{2} \\ {{ω}_{2}}^{2} \\ {{ω}_{3}}^{2} \\ {{ω}_{4}}^{2} \\ {{ω}_{5}}^{2} \\ {{ω}_{6}}^{2} \\ {{ω}_{7}}^{2} \\ {{ω}_{8}}^{2}\end{matrix} ) = ( \begin{matrix}\frac{1}{8 k} & - \frac{\sqrt{2}}{8 lk} & - \frac{\sqrt{2}}{8 lk} & \frac{1}{8 b} \\ \frac{1}{8 k} & - \frac{\sqrt{2}}{8 lk} & \frac{\sqrt{2}}{8 lk} & - \frac{1}{8 b} \\ \frac{1}{8 k} & \frac{\sqrt{2}}{8 lk} & \frac{\sqrt{2}}{8 lk} & \frac{1}{8 b} \\ \frac{1}{8 k} & \frac{\sqrt{2}}{8 lk} & - \frac{\sqrt{2}}{8 lk} & - \frac{1}{8 b} \\ \frac{1}{8 k} & - \frac{\sqrt{2}}{8 lk} & - \frac{\sqrt{2}}{8 lk} & - \frac{1}{8 b} \\ \frac{1}{8 k} & - \frac{\sqrt{2}}{8 lk} & \frac{\sqrt{2}}{8 lk} & \frac{1}{8 b} \\ \frac{1}{8 k} & \frac{\sqrt{2}}{8 lk} & \frac{\sqrt{2}}{8 lk} & - \frac{1}{8 b} \\ \frac{1}{8 k} & \frac{\sqrt{2}}{8 lk} & - \frac{\sqrt{2}}{8 lk} & \frac{1}{8 b}\end{matrix} ) ( \begin{matrix}T - 2 {k}_{m} {{ω}_{m}}^{2} \\ {τ}_{ϕ} \\ {τ}_{θ} \\ {τ}_{ψ}\end{matrix} ) \qquad Equation 4$$

Therefore, once T−2kₘωₘ², τ_{φ}, τ_{θ}, τ_{ψ}, are determined, the rotational speeds of the sub-rotors 12 ω₁, ω₂, ω₃, ω₄, ω₅, ω₆, ω₇, ω₈ can be determined by the calculation in Equation 4. T−2kₘωₘ² corresponds to the total thrust of the plurality of sub-rotors 12. While T−2kₘωₘ² includes the unknown ωₘ, when the ratio between the total thrust of the main rotors 22 and the total thrust of the sub-rotors 12 is fixed, T−2kₘωₘ² can be determined. T−2kₘωₘ² can be calculated by multiplying T by a constant coefficient. For example, if the ratio between the total thrust of the main rotors 22 and the total thrust of the sub-rotors 12 is fixed at 6:4, T−2kₘωₘ² can be determined by multiplying T by the coefficient 0.4. Also, if the ratio between the total thrust of the main rotors 22 and the total thrust of the sub-rotors 12 is fixed at, for example, 3:7, T−2kₘωₘ² can be determined by multiplying T by the coefficient 0.7. Therefore, when the ratio between the total thrust of the main rotors 22 and the total thrust of the sub-rotors 12 is fixed, if the total thrust T of all rotors and the torques τ_{φ}, τ_{θ}, τ_{ψ}, around each axis are determined, the rotational speeds of the sub-rotors 12 ω₁, ω₂, ω₃, ω₄, ω₅, ω₆, ω₇, ω₈ can be determined by the calculation in Equation 4. Additionally, by multiplying the total thrust from all rotors T or the total thrust from the sub-rotors 12 T−2kₘωₘ² by a predetermined coefficient, the total thrust from the main rotors 22 2kₘωₘ² can be calculated. Since kₘ is known, ωₘ can be calculated from the value of 2kₘωₘ².

As described above, the controller 30 can determine the rotational speeds of the sub-rotors 12 ω₁, ω₂, ω₃, ω₄, ω₅, ω₆, ω₇, ω₈ and the rotational speed of the main rotors 22 ωₘ based on the desired thrust T and torques τ_{φ}, τ_{θ}, τ_{ψ}, around each axis, and the relationship in Equation 4.

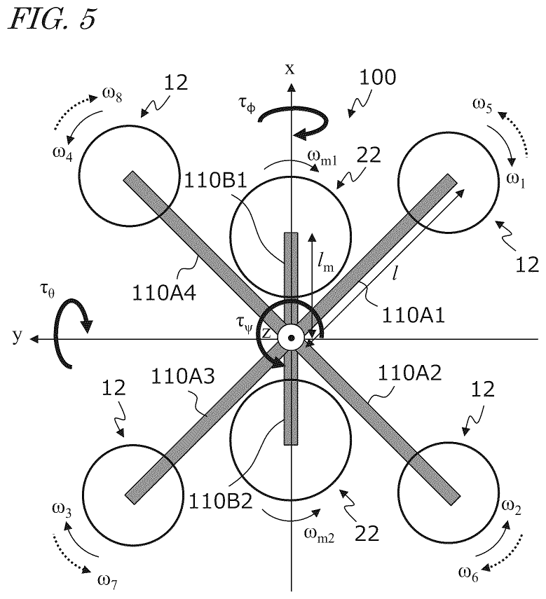

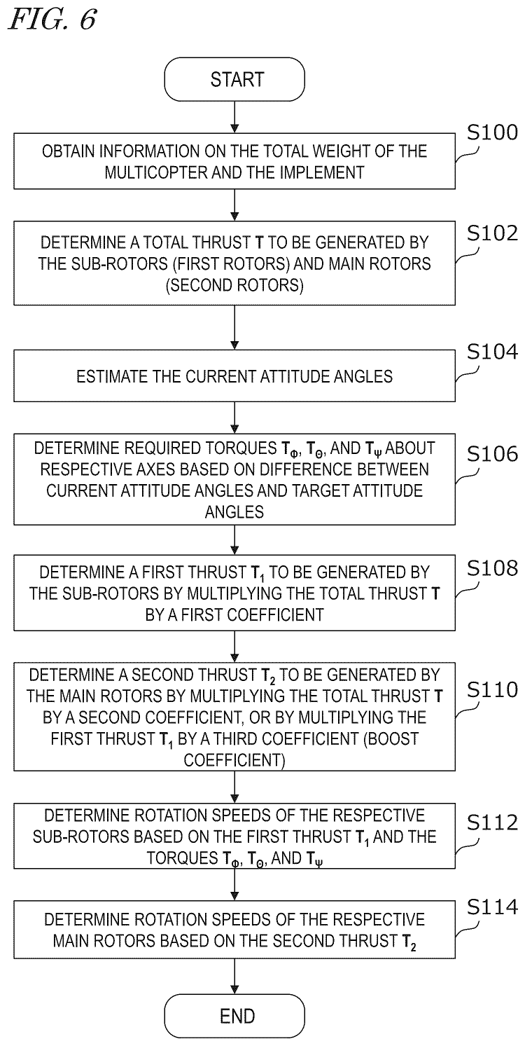

Below, an example of the process for determining the rotational speed of each rotor by the controller 30 will be explained with reference to FIG. 6.

FIG. 6 is a flowchart showing an example of processing to determine the rotational speed of each sub-rotor 12 and each main rotor 22. The processing shown in FIG. 6 may be executed by, for example, the flight controller 32 in the controller 30. The controller 30 can determine the rotational speeds of the eight sub-rotors 12 ω₁, ω₂, ω₃, ω₄, ω₅, ω₆, ω₇, ω₈ and the rotational speed of each main rotor 22 ωₘ by executing the processing from steps S100 to S114.

In step S100, the controller 30 obtains information about the total weight of the multicopter 100 and the implement 200. The total weight information may be stored in a storage device in advance. Alternatively, the weight of the multicopter 100 may be stored in a storage device in advance, and the weight of the implement 200 may be measured by a sensor. By providing such a sensor, it is possible to estimate the total weight more accurately even when the weight of the implement 200 changes due to work such as chemical spraying or harvesting. The controller 30 may calculate the total weight of the multicopter 100 and the implement 200 based on data obtained from the storage device or the sensor.

In step S102, the controller 30 determines the total thrust T that should be generated by the plurality of sub-rotors 12 and the plurality of main rotors 22 (total thrust). The controller 30 can determine the total thrust T based on the information about the total weight of the multicopter 100 and the implement 200, and the flight state. For example, during hovering, the controller 30 can determine the total thrust T as a thrust that balances with the total weight of the multicopter 100 and the implement 200. During horizontal flight, the controller 30 can determine the total thrust T based on the condition that the vertical component of the thrust balances with gravity, taking into account the inclination of the aircraft. During ascent or descent, the controller 30 determines the total thrust T so that the aircraft ascends or descends with the desired acceleration.

In step S104, the controller 30 estimates the current attitude angle of the multicopter 100 based on data obtained from one or more sensors such as an IMU and geomagnetic sensor. The attitude angle represents the inclination of the multicopter 100 from its reference attitude in a coordinate system fixed to the ground.

In step S106, the controller 30 determines the necessary torques τ_{φ}, τ_{θ}, τ_{ψ} around each axis based on the difference between the current attitude angle of the multicopter 100 and the target attitude angle. The target attitude angle may be determined according to, for example, user operation using a controller or a pre-set flight program. The controller 30 may, for example, determine larger values for each torque as the difference from the target angle becomes larger for the roll angle, pitch angle, and yaw angle respectively.

Note that the processing in steps S104 and S106 may be performed before the processing in steps S100 and S102, or may be performed in parallel.

In step S108, the controller 30 determines a first thrust T₁, which is the total thrust to be generated by the plurality of sub-rotors 12, by multiplying the total thrust T determined in step S102 by a first coefficient K₁ ranging from 0 to 1 inclusive. The first coefficient K₁ may be set to a predetermined value such as 0.4.

In step S110, the controller 30 determines a second thrust T₂, which is the total thrust to be generated by the plurality of main rotors 22, by either multiplying the total thrust T by a second coefficient K₂ (=1−K₁), which is the value obtained by subtracting the first coefficient from 1, or by multiplying the first thrust T₁ by a third coefficient K₃ (=K₂/K₁), which is the value obtained by dividing the second coefficient K₂ by the first coefficient K₁. The calculation of multiplying the total thrust T by the second coefficient K₂ and the calculation of multiplying the first thrust T₁ by the third coefficient K₃ yield the same result.

The ratio between the second thrust T₂, which is the total thrust of the main rotors 22, and the first thrust T₁, which is the total thrust of the sub-rotors 12, may be set to a predetermined ratio such as 6:4. If T₂:T₁=6:4, then the first coefficient is 0.4, the second coefficient is 0.6, and the third coefficient is 1.5. If T₂:T₁=5:5, then the first coefficient is 0.5, the second coefficient is 0.5, and the third coefficient is 1. If T₂:T₁=2:8, then the first coefficient is 0.8, the second coefficient is 0.2, and the third coefficient is 0.25. The third coefficient corresponds to T₂/T₁ and may be referred to as the “boost coefficient”. The first thrust T₁ corresponds to T−2kₘωₘ² in Equation 4, and the second thrust T₂ corresponds to 2kₘωₘ² in Equation 4.

In step S112, the controller 30 executes the calculation shown in Equation 4 based on the determined first thrust T₁ (=T−2kₘωₘ²) and the necessary torques τ_{φ}, τ_{θ}, τ_{ψ}, around each axis. This allows the controller 30 to determine the rotational speeds of the sub-rotors 12 ω₁, ω₂, ω₃, ω₄, ω₅, ω₆, ω₇, ω₈.

In step S114, the controller 30 determines the rotational speed ωₘ of each main rotor 22 from the relationship T₂=2kₘωₘ², based on the second thrust T₂ determined in step S106.

Through the above process, the controller 30 can determine the rotational speed of each rotor based on the desired total thrust T and the necessary torques τ_{φ}, τ_{θ}, τ_{ψ}, around each axis. Instead of the processing in step S110 described above, the controller 30 may calculate the second thrust T₂ by subtracting the first thrust T₁ from the total thrust T needed for flight. Such a calculation can also determine the second thrust T₂.

The controller 30 controls each motor 14 and the internal combustion engine (main rotor driver 24) based on the determined rotational speeds of each sub-rotor 12 and each main rotor 22. The controller 30 controls each motor 14 through each ESC 16 by sending motor control signals (e.g., PWM signals) indicating the determined rotational speeds of the sub-rotors 12 to each ESC 16. Additionally, the controller 30 controls the internal combustion engine by sending a control signal indicating the determined rotational speed of the main rotors 22 to the main rotor controller 26. These operations are repeatedly executed during flight.

In this way, the controller 30 of the present example embodiment calculates a first thrust T₁, which is the total thrust to be generated by the plurality of sub-rotors 12, and calculates a second thrust T₂, which is the total thrust to be generated by the main rotors 22, based on the first thrust T₁ and the total thrust T needed for flight. The controller 30 determines the rotational speed of each of the plurality of sub-rotors 12 ω₁˜ω₈ based on the first thrust T₁, and determines the rotational speed of each main rotor 22 ωₘ based on the second thrust T₂. More specifically, the controller 30 determines the total thrust T to be generated by the plurality of sub-rotors 12 (first rotors) and the plurality of main rotors 22 (second rotors), and determines the first thrust T₁, which is the total thrust to be generated by the plurality of sub-rotors 12, by multiplying the total thrust T by a first coefficient K₁. The controller 30 further determines the second thrust T₂, which is the total thrust to be generated by the plurality of main rotors 22, by either subtracting the first thrust T₁ from the total thrust T, multiplying the total thrust T by a second coefficient K₂ (=1−K₁), or multiplying the first thrust T₁ by a third coefficient (=(1−K₁)/K₁). The controller 30 determines the rotational speed of each of the plurality of sub-rotors 12 based on the first thrust T₁, and determines the rotational speed of each of the plurality of main rotors 22 based on the second thrust T₂.

Through these operations, the controller 30 can sequentially determine the rotational speeds of each sub-rotor 12 and each main rotor 22 during flight, and rotate each sub-rotor 12 and each main rotor 22 at the determined rotational speeds. This makes it possible to bring the multicopter 100 closer to the target attitude and execute the desired flight.

Note that in the examples of FIGS. 3A and 5, the multicopter 100 includes two main rotors 22 and eight sub-rotors 12, but the number of main rotors 22 and sub-rotors 12 is not limited to this example. For example, the number of main rotors 22 may be one or three or more. Additionally, the number of sub-rotors 12 may be a different number such as 4 or 6. Regarding the sub-rotors 12, various configurations such as quadcopter, hexacopter, or octocopter can be adopted, not limited to the octo-quadcopter configuration shown in FIGS. 3A and 5.

In the operation described above, the first coefficient K₁, and the second coefficient K₂ or the third coefficient K₃ may be variable. In other words, the boost coefficient T₂/T₁ (corresponding to the third coefficient K₃), which is the ratio between the total thrust T₂ from the main rotors 22 and the total thrust T₁ from the sub-rotors 12, may be variable. The boost coefficient corresponds to the ratio between the total thrust from the main rotors 22 (second thrust) obtained from the main rotor driver 24 and the total thrust from the sub-rotors 12 (first thrust) obtained from the plurality of motors 14. The controller 30 may change the first coefficient K₁, and the second coefficient K₂ or the third coefficient K₃, according to the state of the multicopter 100. For example, the controller 30 may change the first coefficient K₁, and the second coefficient K₂ or the third coefficient K₃, according to the flight mode. Flight modes include, for example, hovering, horizontal flight (forward, backward, or lateral movement (aileron)), ascent, descent, and rotation (rudder). The controller 30 may be configured or programmed to maintain the first coefficient K₁ at a value less than about 0.5 during ascent and hovering, for example. When maintaining the first coefficient K₁ at a value less than about 0.5, the second coefficient K₂ is maintained at a value greater than about 0.5, and the third coefficient K₃ (boost coefficient) is maintained at a value greater than about 1, for example. This enables efficient generation of large thrust by the main rotors 22. The controller 30 may set the boost coefficient to a value smaller than the value during hovering (e.g., a value less than 1) when adjusting the attitude of the aircraft (yaw, pitch, and/or roll) for landing, horizontal flight, or rudder, etc. This can prevent the large thrust and rotational moment generated by the rotation of the main rotors 22 from interfering with the attitude control function of the sub-rotors 12.

The controller 30 may be configured or programmed to change the first coefficient K₁, and the second coefficient K₂ or the third coefficient K₃, in response to user operation using an external device such as a controller or remote monitoring device. This allows the user to adjust the balance between thrust generation efficiency and attitude control responsiveness, for example, to make it easier to pilot.

Next, as an example of attitude control in this example embodiment, an example of rudder control operation will be explained.

Attitude control of the multicopter 10 is performed by bringing the yaw, pitch, and roll angles of the aircraft closer to target angles. Among these, the control to bring the yaw angle closer to a target angle is called “rudder control”. The following describes a control method to prevent the actual yaw angle of the aircraft from deviating from the target angle during rudder control. Note that the following control method can be similarly applied to control for adjusting the pitch angle or roll angle of the aircraft, not limited to rudder control.

The controller 30 may be configured or programmed to reduce (or eliminate) the total thrust or rotational speed of the main rotors 22 and instead increase the total thrust or rotational speed of the sub-rotors 12 when performing rudder control to adjust the yaw angle of the aircraft to a target angle. Reducing the total thrust or rotational speed of the main rotors 22 can reduce variations in attitude angles during rudder control and stabilize the attitude.

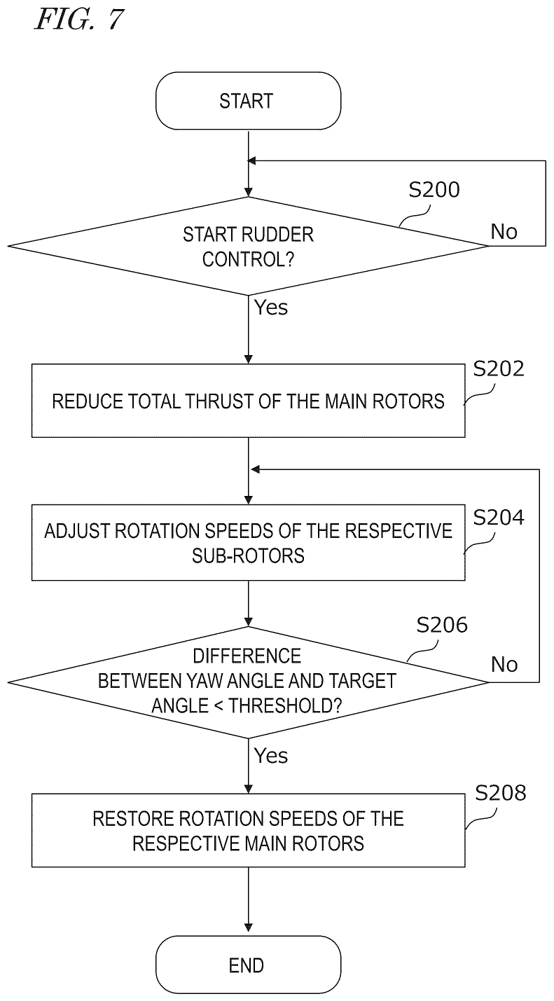

FIG. 7 is a flowchart showing an outline of the operation of the controller 30 related to rudder control. By executing the processing shown in FIG. 7 during the flight of the multicopter 100, the controller 30 is configured or programmed to execute control to bring the yaw angle of the aircraft closer to the target angle.

First, in step S200, the controller 30 determines whether to start rudder control. The controller 30 may determine whether to start rudder control based on, for example, commands from an external device such as a controller or remote monitoring device used by the user, or a pre-set flight program. Rudder control may be performed, for example, when changing or maintaining the direction of the aircraft in a desired direction for changing the flight direction or landing. The controller 30 performs rudder control when controlling to a target yaw angle, when a control delay in the yaw angle occurs, or when rotation or oscillation in the yaw direction occurs. When the controller 30 determines to start rudder control, it proceeds to step S202.

In step S202, the controller 30 reduces the total thrust of the main rotors 22. For example, by decreasing the boost coefficient, the rotational speed of each main rotor 22 can be reduced, thereby reducing the total thrust of the main rotors 22. As mentioned earlier, the controller 30 may be configured or programmed to set the boost coefficient to a value greater than 1 during hovering, making the total thrust T₂ of the plurality of main rotors 22 greater than the total thrust T₁ of the plurality of sub-rotors 12. In contrast, when executing rudder control, the controller 30 can control the total thrust T₂ of the plurality of main rotors 22 to be less than the total thrust T₁ of the plurality of sub-rotors 12 by changing the boost coefficient to a value less than 1. The controller 30 may decrease the rotational speed of each of the plurality of main rotors 22 to reduce the total thrust of the plurality of main rotors 22 by 5% or more when performing the rudder control. For example, the controller 30 may decrease the rotational speed of each of the plurality of main rotors 22 to less than about 70%, less than about 50%, less than about 30%, or less than about 10% of the rotational speed of each of the plurality of main rotors 22 during hovering. Alternatively, the controller 30 may stop the rotation of each of the plurality of main rotors 22 when performing the rudder control. In other words, the controller 30 may change the boost coefficient to 0 (zero) when performing the rudder control.

In step S204, the controller 30 adjusts the rotational speed of each sub-rotor 12. The controller 30 can determine the rotational speed of each sub-rotor 12 by a process similar to step S112 shown in FIG. 6. At this time, the rotational speed of each sub-rotor 12 increases to compensate for the thrust reduction due to the decrease in the rotational speed of the main rotors 22. In other words, the controller 30 compensates for the decreased total thrust of the plurality of main rotors 22 due to the decreased rotational speed of each of the plurality of main rotors 22 by increasing the rotational speed of the plurality of sub-rotors 12. The controller 30 inputs motor control signals indicating the determined rotational speeds to the respective ESCs 16.

In step S206, the controller 30 determines whether the difference between the current yaw angle and the target angle is less than a threshold. The threshold is set to a sufficiently small value close to 0 degrees. If the difference between the current yaw angle and the target angle is equal to or greater than the threshold (No case), return to step S204. If the difference between the current yaw angle and the target angle is less than the threshold (Yes case), end the rudder control and proceed to step S208.

In step S208, the controller 30 returns the rotational speed of each main rotor 22 to its original speed. For example, the controller 30 returns the rotational speed of each main rotor 22 to its original value by returning the boost coefficient to the value before the change in step S202. Accordingly, the rotational speed of each sub-rotor 12 is also adjusted to return to its original value.

The operation shown in FIG. 7 may be repeatedly executed by, for example, the flight controller 32 of the controller 30 during the flight of the multicopter 10.

Through the above operations, the controller 30 can reduce the thrust generated by the plurality of main rotors 22 by decreasing the rotational speed of each main rotor 22 when executing rudder control. This can reduce variations in the yaw angle during rudder control and make it easier to approach the desired angle. According to numerical experiments conducted by the present inventors, it was confirmed that the closer the boost coefficient is to 0, the more the variation in the yaw angle can be reduced when performing rudder control.

The above control can be applied not only to rudder control for adjusting the yaw angle of the aircraft but also to control for adjusting the roll angle and/or pitch angle of the aircraft. That is, the controller 30 may reduce the total thrust of the main rotors 22 and increase the total thrust of the sub-rotors 12 when performing attitude control to bring the roll, pitch, and yaw angles of the aircraft closer to target angles. Such control can improve the responsiveness of attitude control.

Next, an example method for controlling the internal combustion engine (engine) will be explained.

As described above, the multicopter 100 of this example embodiment includes a plurality of rotors including a plurality of sub-rotors 12 and at least one main rotor 22. The plurality of sub-rotors 12 are each driven by a plurality of motors 14. The at least one main rotor 22 is driven by the main rotor driver 24, which is an internal combustion engine. The controller 30 is configured or programmed to perform attitude control of the aircraft by controlling the rotation of the plurality of sub-rotors 12 through controlling the plurality of motors 14. The controller 30 generates main thrust by controlling the rotation of the at least one main rotor 22 through controlling the internal combustion engine via the main rotor controller 26.

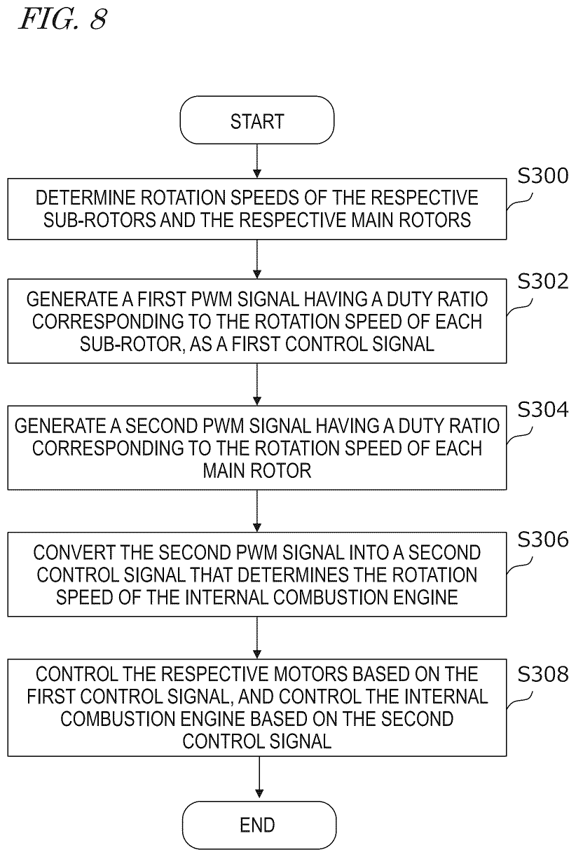

FIG. 8 is a flowchart showing an example of a control method for motors 14 and internal combustion engine. The control method shown in FIG. 8 is executed by the controller 30 and the main rotor controller 26.

In step S300, the controller 30 determines the rotational speed of each sub-rotor 12 and the rotational speed of each main rotor 22. The rotational speed of each rotor may be determined by the method explained with reference to FIG. 6. Hereinafter, the rotational speed of each sub-rotor 12 may be referred to as “first rotational speed” and the rotational speed of each main rotor 22 may be referred to as “second rotational speed”. The first rotational speed is determined individually for each sub-rotor 12. The second rotational speed may be determined individually for each main rotor 22 or may be determined collectively at a common value.

In step S302, the controller 30 generates a first PWM signal with a duty ratio corresponding to the rotational speed of each sub-rotor 12, as a first control signal, for each sub-rotor 12. The first PWM signal corresponds to the motor control signal mentioned earlier. The duty ratio of the PWM signal indicates the motor's rotational speed. Note that the first control signal is not limited to a PWM signal and may be other types of signals.

In step S304, the controller 30 generates a second PWM signal with a duty ratio corresponding to the rotational speed of each main rotor 22. In this example embodiment, each main rotor 22 is driven by an internal combustion engine, but each main rotor 22 may be driven by an electric motor. For example, the configuration of the first rotation driver 3A or the third rotation driver 3C shown in FIG. 1A may be adopted to drive some rotors as main rotors and the remaining rotors as sub-rotors. The controller 30 can generate a second PWM signal to be input to an ESC that would drive such an electric motor for each main rotor 22, if the main rotors were driven by electric motors.

In step S306, the main rotor controller 26 converts the second PWM signal generated by the controller 30 into a second control signal that determines the rotational speed of the internal combustion engine. In this example embodiment, where each main rotor 22 is driven by an internal combustion engine, the second PWM signal for driving an electric motor cannot be used directly for controlling the internal combustion engine. Therefore, the main rotor controller 26 converts the second PWM signal into a second control signal for controlling the internal combustion engine. The second control signal may be, for example, a signal that determines the opening degree of the throttle valve of the internal combustion engine. The main rotor controller 26 can convert the second PWM signal into the second control signal based on data such as a table showing the relationship between the duty ratio of the second PWM signal and the opening degree of the throttle valve, or the relationship between the duty ratio of the second PWM signal and the rotational speed of the internal combustion engine. The duty ratio of the second PWM signal correlates with the rotational speed of each main rotor 22 (second rotational speed). Therefore, a table showing the relationship between the duty ratio of the second PWM signal and the rotational speed of the internal combustion engine corresponds to a table that converts the second rotational speed to the internal combustion engine's rotational speed. Such data may be stored in advance in a storage device internal or external to the controller 30. The controller 30 can convert the second PWM signal into the second control signal by retrieving such data from the storage device and referring to it. The data such as the above table may be stored on a server computer in the cloud. In that case, the controller 30 can obtain the data through the communication device 74.

In step S308, the controller 30 controls each motor 14 by inputting the first control signal generated for each sub-rotor 12 to the respective ESC 16. Additionally, the main rotor controller 26 controls the main rotor driver 24 (internal combustion engine) using the second control signal.

Through the above operations, each motor 14 and the internal combustion engine can be controlled to rotate each sub-rotor 12 and each main rotor 22 at the desired rotational speeds. While in this example embodiment the control shown in FIG. 8 is executed by the controller 30 and the main rotor controller 26, a single controller or control system configured or programmed to perform the functions of the controller 30 and the main rotor controller 26 may be configured or programmed to execute the control shown in FIG. 8. That is, the controller or control system may be configured or programmed to determine the rotational speed of each of the plurality of sub-rotors 12 (first rotational speed) and the rotational speed of at least one main rotor 22 (second rotational speed), generate a first control signal to rotate each of the plurality of motors 14 based on the first rotational speed, and generate a second control signal to drive the internal combustion engine based on the second rotational speed. Such a controller or control system may, for example, generate a signal with a duty ratio corresponding to the first rotational speed of each sub-rotor 12 (e.g., the first PWM signal mentioned above) as the first control signal, generate a signal with a duty ratio corresponding to the second rotational speed of at least one second rotor (e.g., the second PWM signal mentioned above), and convert the second PWM signal into a second control signal that defines the rotational speed of the internal combustion engine based on data such as the aforementioned table.

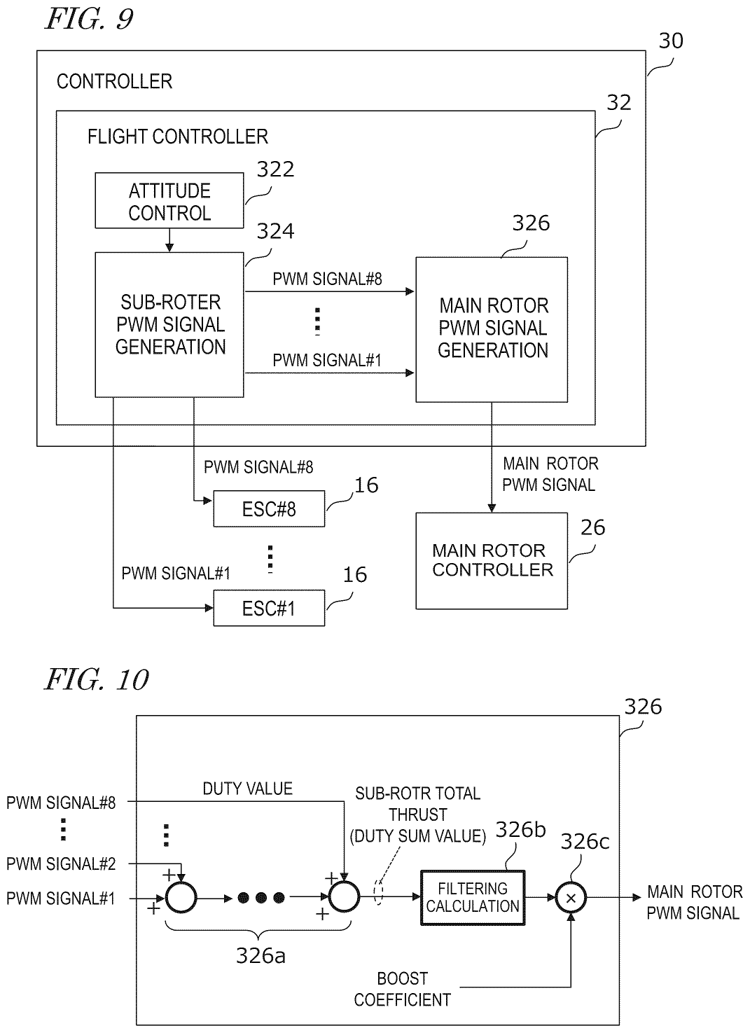

Below, example configurations for implementing the above control will be explained in more detail with reference to FIGS. 9 to 12.

FIG. 9 is a block diagram showing an example configuration of the flight controller 32 in the controller 30. In this example, the flight controller 32 is configured or programmed to include a module 322 that determines the rotational speed of each sub-rotor 12 for attitude control, a module 324 that generates a first PWM signal (first control signal) with a duty ratio corresponding to the rotational speed of each sub-rotor 12, and a module 326 that generates a second PWM signal with a duty ratio corresponding to the rotational speed of each main rotor 22. The first PWM signal is input to each of the plurality of ESCs 16. In the example shown in FIG. 9, PWM signals #1 to #8 are input to eight ESCs 16 corresponding to eight sub-rotors 12 respectively. In the example of FIG. 9, PWM signals #1 to #8 are also input to the module 326 that generates the PWM signal for the main rotors 22. Module 326 generates a PWM signal for the main rotors 22 (second PWM signal) based on these PWM signals #1 to #8, and outputs the second PWM signal to the main rotor controller 26. The main rotor controller 26 converts the second PWM signal into a second control signal, which is an engine control signal, and controls the internal combustion engine based on the second control signal.

FIG. 10 is a diagram showing an example configuration of the module 326 for generating the PWM signal for the main rotors 22. Module 326 includes multiple adders 326a, a filter calculator 326b, and a multiplier 326c. The adders 326a are provided in the same number as the number of sub-rotors 12. The adders 326a add the duty values of the PWM signals #1 to #8 input from module 324 to output a duty sum value. The duty sum value correlates (e.g., is proportional) to the total thrust of the plurality of sub-rotors 12. The signal of the duty sum value is input to the filter calculator 326b. The filter calculator 326b removes high-frequency components from the duty sum value signal, smooths the time variation of the signal, and outputs it. The signal output from the filter calculator 326b is sent to the multiplier 326c. The multiplier 326c generates and outputs a PWM signal for the main rotors 22 by multiplying the signal by a boost coefficient. Note that the functions shown in FIG. 10 may be realized by hardware or by software.

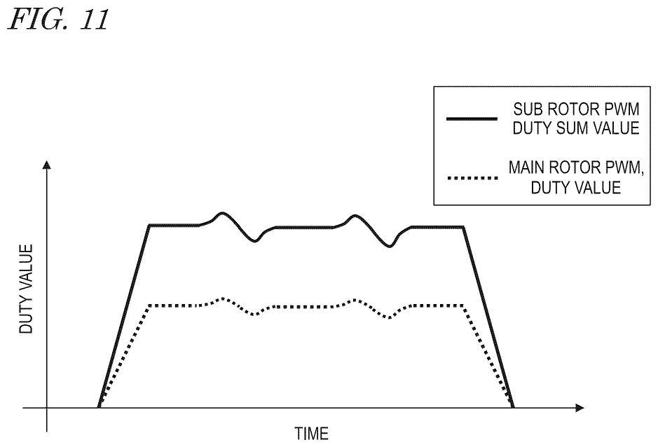

FIG. 11 is a graph showing an example of time variation of duty sum value of PWM signals for sub-rotors and duty value of PWM signal for main rotors. In the example of FIG. 11, the boost coefficient is maintained at a constant value, and the ratio between the duty sum value of the PWM signals for the sub-rotors 12 and the duty value of the PWM signal for the main rotors 22 is constant. As mentioned earlier, the boost coefficient may fluctuate during flight according to the state of the multicopter 100 or commands from external devices.

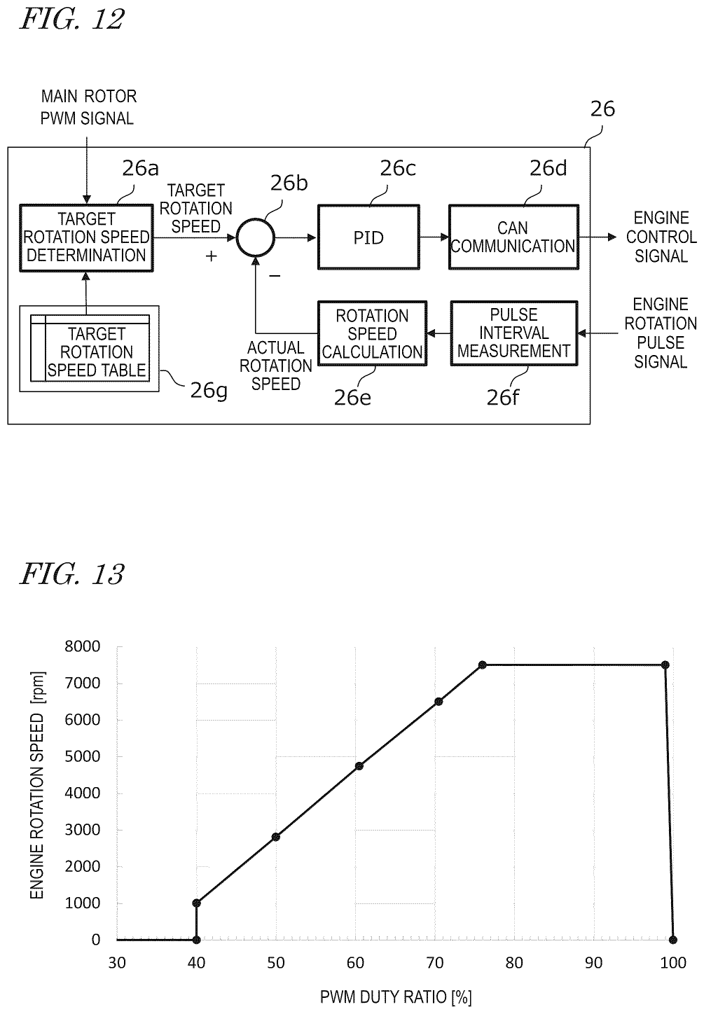

FIG. 12 is a diagram showing an example configuration of the main rotor controller 26. The main rotor controller 26 shown in FIG. 12 includes a module 26a that determines the target rotation speed of the internal combustion engine (engine), a subtractor 26b, a module 26c that executes calculations for PID control, a module 26d that generates signals for CAN communication, a module 26f that measures the pulse interval of engine rotation pulse signals output from sensors installed in the internal combustion engine, and a module 26e that calculates the actual rotation speed of the engine based on the pulse interval. The main rotor controller 26 further includes a storage device 26g that stores a target rotation speed table, which is data showing the relationship between the duty ratio of the PWM signal for the main rotors 22 and the target rotation speed of the engine. Here, the engine rotation speed means the number of revolutions of the engine per unit time (e.g., unit: rpm). Note that the functions shown in FIG. 12 may be realized by hardware or by software.

The main rotor controller 26 determines the target rotation speed of the engine based on the PWM signal for the main rotors 22 output from the flight controller 32 and the target rotation speed table.

FIG. 13 is a graph showing an example of the relationship between PWM signal duty ratio and engine rotation speed. The target rotation speed table may be created in advance based on a relationship as shown in FIG. 13 and stored in the storage device 26g. In this example, the rotational speed of each main rotor 22 is proportional to the duty ratio of the PWM signal. The target rotation speed table is an example of a table that converts the rotational speed of each main rotor 22 into the rotational speed of the internal combustion engine. The main rotor controller 26 can convert the PWM signal into an engine control signal (second control signal) that drives the internal combustion engine based on such a table.

The main rotor controller 26 determines the target rotation speed of the engine while measuring the pulse interval of engine rotation pulse signals output from the sensor and calculating the actual engine rotation speed based on that pulse interval. The main rotor controller 26 performs subtraction between the target rotation speed and the actual rotation speed of the engine, and executes PID control to adjust the engine control signal so that the difference between them approaches zero. The main rotor controller 26 controls the main rotor driver 24 (internal combustion engine) with the engine control signal determined to bring the difference between the target rotation speed and the actual rotation speed of the engine close to zero. This makes it possible to rotate the main rotors 22 at the desired rotational speed.

In the above example, a table showing the relationship between the PWM signal duty ratio and the engine target rotation speed is used, but alternatively, data such as a table showing the relationship between the PWM signal duty ratio and the opening degree of the throttle valve of the internal combustion engine may be used. Based on such data, the main rotor controller 26 can convert the PWM signal for the main rotors 22 (second PWM signal) into an engine control signal indicating the opening degree of the throttle valve. Such an engine control signal can be used as a second control signal to drive the internal combustion engine.

As described above, when controlling the rotational speed of each main rotor 22, the flight controller 32 in the controller 30 of this example embodiment generates a PWM signal with a duty ratio corresponding to the rotational speed. The main rotor controller 26 converts the PWM signal into an engine control signal based on a table that defines a relationship such as that shown in FIG. 13, and controls the internal combustion engine using the engine control signal. With this configuration, it is possible to reuse a flight controller used in a battery-driven or series hybrid drive type where the main rotors 22 are driven by electric motors, in the parallel hybrid drive type configuration of this example embodiment. Therefore, it is possible to control the internal combustion engine that drives the main rotors 22 in the parallel hybrid drive type without changing the flight controller.

The controller 30 of the present example embodiment of the present disclosure may be realized by a digital computer system configured or programmed to execute each process described with reference to FIGS. 6 to 8.

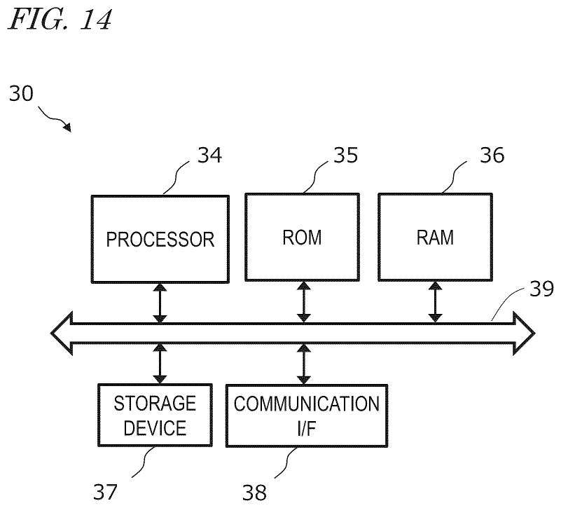

FIG. 14 is a block diagram showing an example of hardware configuration of the controller 30. The controller 30 may include a processor 34, ROM (Read Only Memory) 35, RAM (Random Access Memory) 36, storage device 37, and communication I/F 38. These components are interconnected via a bus 39.

The processor 34 may include one or more semiconductor integrated circuits, also referred to as a central processing unit (CPU) or microprocessor. The processor 34 sequentially executes computer programs stored in ROM 35 to implement the aforementioned processing. The processor 34 is broadly interpreted to include terms such as FPGA (Field Programmable Gate Array) with CPU, GPU (Graphic Processor Unit), ASIC (Application Specific Integrated Circuit), or ASSP (Application Specific Standard Product).

The ROM 35 is, for example, a writable memory (for example, PROM), rewritable memory (for example, flash memory), or read-only memory. The ROM 35 stores programs that control the operation of the processor. The ROM 35 need not be a single recording medium but may be a collection of a plurality of recording media. Part of the plurality of collections of recording media may be removable memory.

The RAM 36 provides a work area for temporarily expanding programs stored in the ROM 35 during boot-up. The RAM 36 need not be a single recording medium but may be a collection of a plurality of recording media.

The communication I/F 38 is an interface for communication between the controller 30 and other electronic components or electronic controllers (ECUs). For example, the communication I/F 38 may perform wired communication complying with various protocols. The communication I/F 38 may perform wireless communication complying with Bluetooth® standards and/or Wi-Fi® standards. Both standards include wireless communication standards utilizing the 2.4 GHz frequency band.

The storage device 37 may be, for example, a semiconductor memory, magnetic storage device, or optical storage device, or a combination thereof. The storage device 37 is configured to store, for example, map data useful for autonomous flight of the multicopter 10, and various sensor data acquired by the multicopter 10 during flight.

Note that, as mentioned earlier, the controller 30 may be configured or programmed to include, as separate components, a flight controller such as the flight controller 32 and an upper-level computer (companion computer). Also, a system including the controller 30 and the main rotor controller 26 may be used as a “controller”.

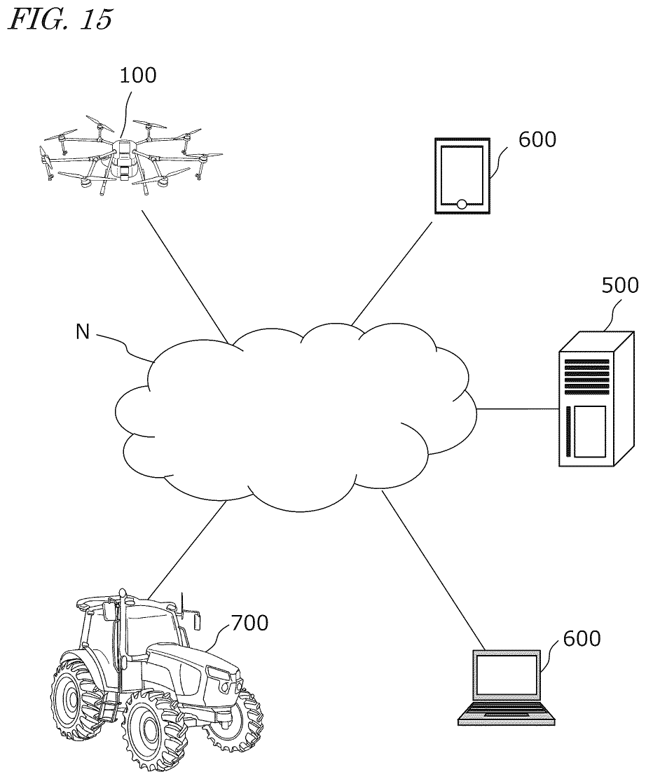

Additionally, some or all of the functions of the controller 30 may be realized by one or more servers (computers) 500 or terminal devices (including portable and fixed types) 400 connected to the communication device 74 of the multicopter 100 via a communication network N, as shown in FIG. 15. Agricultural machines 700 such as tractors may be connected to this communication network N, and communication may be performed between the multicopter 100 and the agricultural machine 700. A portion of the data used for processing by the controller 30 and control signals for the multicopter 100 may be provided to the multicopter 100 from the agricultural machine 700 through the communication network N.

In the unmanned aerial vehicles according to the above example embodiments, the “attitude controller” includes a plurality of electric motors, and the “main thrust generating device” includes an internal combustion engine. In other words, the unmanned aerial vehicles according to the above example embodiments include the rotation driver 3D shown in FIG. 1A. However, even with the rotation drivers 3A, 3B, and 3C shown in FIG. 1A, an unmanned aerial vehicle including both an “attitude controller” and a “main thrust generating device” can be realized by making some motors 14 or power transmission systems 23 different from other motors 14 or power transmission systems 23.

Additionally, the unmanned aerial vehicles may each include a plurality of internal combustion engines having different outputs and response speeds. In such a case, the internal combustion engine with relatively low output and relatively high response speed may constitute the “attitude controller,” while the internal combustion engine with relatively high output and relatively low response speed may constitute the “main thrust generating device”.

Unmanned aerial vehicles according to example embodiments of the present disclosure may be widely utilized not only for aerial photography, surveying, logistics, and agricultural chemical spraying applications but also for ground work related to agriculture, transportation of harvested crops and agricultural materials.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle comprising:
a plurality of rotors including a plurality of first rotors and at least one second rotor; and
a controller configured or programmed to perform attitude control of a body of the vehicle by controlling rotation of the plurality of first rotors, and generate a main thrust by controlling rotation of the at least one second rotor; wherein
the controller is configured or programmed to:
calculate a first thrust that is a total thrust to be generated by the plurality of first rotors, and calculate a second thrust that is a total thrust to be generated by the at least one second rotor, based on the first thrust and a total thrust needed for flight;
determine a rotational speed of each of the plurality of first rotors based on the first thrust; and
determines a rotational speed of the at least one second rotor based on the second thrust.

2. The unmanned aerial vehicle according to claim 1, wherein the controller is configured or programmed to calculate the second thrust by subtracting the first thrust from the total thrust needed for flight.

3. The unmanned aerial vehicle according to claim 1, wherein the controller is configured or programmed to:
determine the first thrust by multiplying the total thrust needed for flight by a first coefficient ranging from 0 to 1 inclusive; and
determine the second thrust by multiplying the total thrust by a second coefficient that is obtained by subtracting the first coefficient from 1, or by multiplying the first thrust by a third coefficient that is obtained by dividing the second coefficient by the first coefficient.

4. The unmanned aerial vehicle according to claim 3, wherein the controller is configured or programmed to change the first coefficient, and the second coefficient or the third coefficient, according to a state of the unmanned aerial vehicle.

5. The unmanned aerial vehicle according to claim 3, wherein the controller is configured or programmed to set the first coefficient to a value less than about 0.5 during hovering.

6. The unmanned aerial vehicle according to claim 3, wherein the controller is configured or programmed to determine the second thrust by multiplying the first thrust by the third coefficient.

7. The unmanned aerial vehicle according to claim 3, wherein the controller is configured or programmed to change the first coefficient, and the second coefficient or the third coefficient, according to the flight mode.

8. The unmanned aerial vehicle according to claim 3, wherein the controller is configured or programmed to change the first coefficient, and the second coefficient or the third coefficient, in response to user operation.

9. The unmanned aerial vehicle according to claim 1, wherein a diameter of the at least one second rotor is larger than a diameter of each of the plurality of first rotors.

10. The unmanned aerial vehicle according to claim 1, wherein a thrust per revolution of each of the plurality of second rotors is greater than a thrust per revolution of each of the plurality of first rotors.

11. The unmanned aerial vehicle according to claim 1, wherein a distance from a center of the body to a rotation axis of each of the plurality of second rotors is shorter than a distance from the center of the body to a rotation axis of each of the plurality of first rotors.

12. The unmanned aerial vehicle according to claim 1, further comprising:
a plurality of electric motors each configured to drive a respective one of the plurality of first rotors; and
an internal combustion engine to drive the at least one second rotor; wherein
the controller is configured or programmed to control rotation of the plurality of first rotors by controlling the plurality of electric motors, and control rotation of the at least one second rotor by controlling the internal combustion engine.

13. A control method performed by a controller in an unmanned aerial vehicle including a plurality of rotors including a plurality of first rotors and at least one second rotor, and the controller configured or programmed to perform attitude control of a body of the vehicle by controlling rotation of the plurality of first rotors, and generate a main thrust by controlling rotation of the at least one second rotor, the control method comprising:
calculating a first thrust to be generated by the plurality of first rotors;
calculating a second thrust to be generated by the at least one second rotor based on the first thrust and a total thrust needed for flight;
determining a rotational speed of each of the plurality of first rotors based on the first thrust; and
determining a rotational speed of the at least one second rotor based on the second thrust.
